(19) United States
(12) Patent Application Publication
(10) Pub. No.: US 2026/0289092 A1
(43) Pub. Date: Sep. 24, 2026

(54) SYSTEM

(71) Applicant: SoftBank Group Corp., Tokyo (JP)

(72) Inventor: Yoshitaka SHIRAI, Tokyo (JP)

(73) Assignee: SoftBank Group Corp., Tokyo (JP)

(21) Appl. No.: 19/568,904

(22) Filed: Mar. 17, 2026

(30) Foreign Application Priority Data
Mar. 19, 2025 (JP) 2025-045258

(51) Int. Cl. G06F 40/166; G06F 40/284; G06F 40/30

(52) U.S. Cl. CPC G06F 40/166; G06F 40/284; G06F 40/30

(57) ABSTRACT

A system comprising a processor, wherein the processor is configured to: acquire, from an information processing apparatus of a user, an operation log and display content, arrange the acquired operation log and display content in chronological order and remove noise therefrom to generate organized data, apply a generative artificial intelligence model to the organized data to learn behavior patterns of the user, generate, based on the learned behavior patterns, a summary of work content of the user or materials related to the work content of the user, recognize an emotion of the user, and adjust content of the summary or the materials in consideration of the recognized emotion.

### CROSS-REFERENCE TO RELATED APPLICATION

This application is based on and claims priority under 35 USC 119 from Japanese Patent Application No. 2025-045258 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for recording and analyzing user activities on information processing apparatuses mainly focus on simple logging or statistical aggregation of operation histories. Such systems generally acquire operation logs, such as keyboard inputs or mouse operations, and may additionally track applications or documents used by the user. However, these systems do not sufficiently capture the semantic content of the displayed information, nor do they fully utilize advanced generative artificial intelligence models to understand high-level behavior patterns of the user. As a result, it is difficult to automatically generate summaries or materials that accurately reflect the user's actual work content and context throughout a day or over a longer period.

Furthermore, conventional systems rarely consider the user's emotional state when generating summaries or materials. Even when work activities are captured in detail, the generated output may not align with the user's current mental or emotional condition, which can reduce the usefulness, acceptance, and readability of the generated content. For example, a user under high stress may prefer concise and supportive summaries, while a user in a neutral state may require more detailed, analytical materials. Existing techniques do not provide a mechanism for recognizing user emotion from operation logs and display content, nor for adjusting the generated output in response to such recognized emotion.

Accordingly, there is a need for a system that is capable of acquiring operation logs and display content from a user's information processing apparatus, organizing and cleansing this data, learning user behavior patterns using a generative artificial intelligence model, and automatically generating work summaries or materials that accurately reflect the user's activities. In addition, there is a need for such a system to recognize the user's emotion and adjust the content of the generated summaries or materials in consideration of the recognized emotion, thereby improving relevance, usability, and user satisfaction.

### SUMMARY

In order to solve the above-described problems, an embodiment of the present invention provides a system comprising a processor, wherein the processor is configured to acquire, from an information processing apparatus of a user, an operation log and display content, arrange the acquired operation log and display content in chronological order and remove noise therefrom to generate organized data, and apply a generative artificial intelligence model to the organized data to learn behavior patterns of the user. The processor is further configured to generate, based on the learned behavior patterns, a summary of work content of the user or materials related to the work content of the user, to recognize an emotion of the user, and to adjust content of the summary or the materials in consideration of the recognized emotion.

According to one aspect, the processor is configured to learn, in chronological order, the acquired operation log and display content, and to estimate both the behavior patterns and the emotion of the user. By performing learning in chronological order, the system can capture temporal relationships among tasks, detect recurring routines, and infer context transitions, thereby enabling more accurate behavior pattern modeling and emotion estimation over time. According to another aspect, the processor is configured to generate the summary or the materials based on the acquired operation log and display content in response to an inquiry from the user, and to further adjust the content of the summary or the materials based on an emotion estimated by an emotion analysis unit. In this manner, when the user issues a query such as a request for a daily work summary or for meeting materials, the system can select and structure relevant log segments using the learned behavior patterns, generate natural language output via the generative artificial intelligence model, and then modify the style, level of detail, or emphasis of the generated output according to the recognized emotion of the user.

Through these means, the system can automatically produce summaries and work-related materials that not only reflect the actual activities of the user as captured by operation logs and display content, but are also adaptively tailored to the user's emotional state, thus enhancing practicality, efficiency, and user experience.

The term “system” refers to an arrangement of one or more hardware and/or software components that cooperatively perform the functions described in the present specification, and may include servers, client devices, networks, storage devices, and executable programs.

The term “processor” refers to any hardware capable of executing instructions, including but not limited to a central processing unit (CPU), a graphics processing unit (GPU), a microcontroller, an application specific integrated circuit (ASIC), a field programmable gate array (FPGA), or a combination thereof, and may execute software modules to perform the functions described herein.

The term “information processing apparatus” refers to any electronic device capable of executing applications and processing data for a user, including but not limited to a personal computer, a notebook computer, a tablet, a smartphone, a workstation, or a thin client terminal.

The term “operation log” refers to data representing operations performed by the user on the information processing apparatus, including but not limited to keyboard inputs, mouse actions, touch inputs, application launches, file accesses, and other user interaction events, together with associated timestamps and contextual information.

The term “display content” refers to information presented on a display screen of the information processing apparatus during operation, including but not limited to application windows, document contents, web pages, images, and graphical user interface elements, as well as associated metadata such as window titles and URLs.

The term “organized data” refers to data obtained by arranging the acquired operation log and display content in chronological order and by removing noise or redundant information, such that the data becomes suitable for analysis and input to a generative artificial intelligence model.

The term “noise” refers to data contained in the acquired operation log and display content that is irrelevant, redundant, erroneous, or otherwise not useful for learning user behavior patterns or generating summaries or materials, including but not limited to repeated identical events, incomplete records, and unintended operations.

The term “generative artificial intelligence model” refers to a machine learning model configured to generate new data, such as natural language text, from given input data, and includes, for example, large language models based on neural networks capable of producing summaries, explanations, or draft documents from operation logs and display content.

The term “behavior patterns” refers to recurring or characteristic sequences, tendencies, or structures in the user's activities over time, including but not limited to typical daily routines, frequently used applications, commonly edited documents, typical sequences of tasks, and preferred working times.

The term “summary of work content” refers to a condensed representation, in natural language or another human-readable form, of the user's work activities over a specified period, derived from the operation log and display content, and highlighting main tasks, projects, and important resources used by the user.

The term “materials related to the work content” refers to documents, reports, presentations, outlines, or other structured information automatically generated based on the operation log and display content and the learned behavior patterns, which can be used for purposes such as meetings, reporting, documentation, or planning.

The term “emotion” refers to a mental or affective state of the user, such as stress level, satisfaction, frustration, motivation, or other psychological conditions, which is estimated or recognized based on the operation log, display content, and optionally additional signals.

The term “recognize an emotion of the user” refers to determining or estimating the emotional state of the user at a given time or over a period, using analysis of the operation log, display content, and outputs of an emotion analysis unit, and optionally using a generative artificial intelligence model or other machine learning techniques.

The term “emotion analysis unit” refers to a functional component implemented by hardware, software, or a combination thereof, configured to analyze the operation log, display content, and possibly other input signals to estimate the emotion of the user, and to output emotion information to be used for adjusting summaries or materials.

The term “adjust content of the summary or the materials” refers to modifying the style, tone, level of detail, structure, emphasis, or other aspects of the generated summary or materials in response to recognized emotion, so that the output is more suitable or acceptable to the user's current emotional state.

The term “inquiry from the user” refers to a request or command provided by the user to the system, typically expressed in natural language or through a user interface, such as a request for a daily work summary or a request to create materials for a specific meeting or topic.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

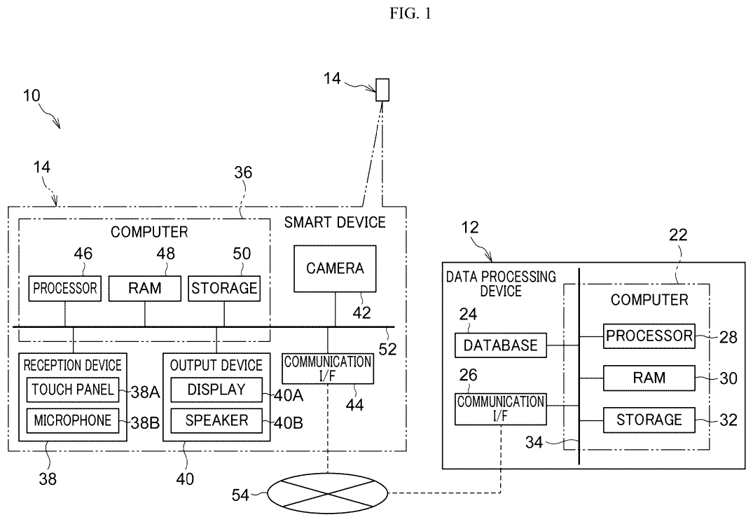

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

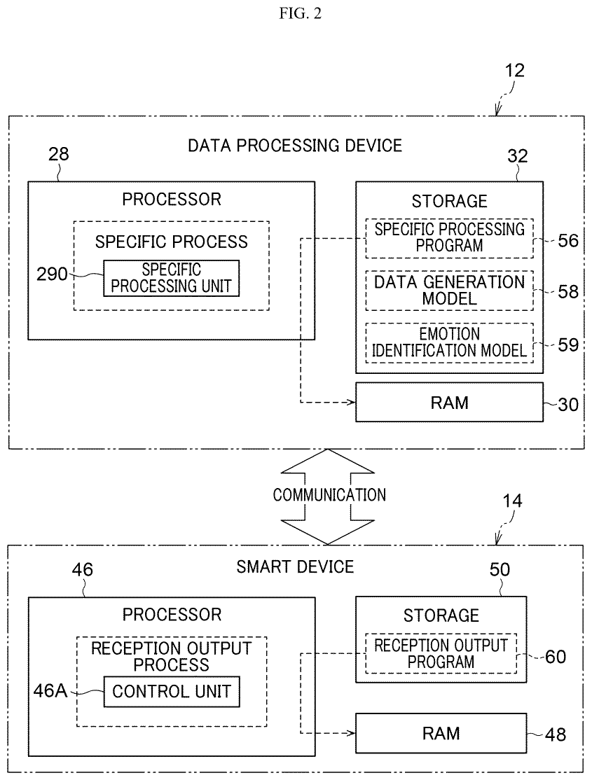

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems that record user activity on information processing terminals typically capture operation logs or partial screen information in an unstructured or loosely structured manner. Such systems often store raw key and mouse events, application switch events, or screen captures without consistently preserving the causal and temporal relationships between user input operations and corresponding display states. As a result, when these raw logs are later analyzed, substantial manual effort or ad hoc scripting is required to reconstruct coherent work sessions, to identify which input operations relate to which documents or network resources, and to derive higher-level user behavior patterns. Furthermore, existing approaches generally treat the recorded activity data as static audit trails rather than as structured, machine-usable representations suitable for advanced machine learning models. In particular, they do not systematically transform low-level operation logs and display contents into normalized, context-linked work session data that can be directly consumed by a generative AI model. This lack of consistent structuring and contextualization leads to inefficiencies, degraded model performance, and limits the ability to automatically generate accurate and user-aligned summaries or documentation of work activities. Additional technical limitations arise in how user requests are handled. Conventional systems that integrate machine learning or natural language processing often apply a generative model to generic text inputs, but they are not configured to interpret a user's natural-language prompt sentence as a query over a large, time-ordered activity dataset. They typically do not perform server-side retrieval and preprocessing of relevant chronological work session data conditioned on time and content constraints extracted from the prompt. Consequently, the generative model either operates on incomplete context or must process excessively raw data, leading to poor efficiency, increased computational load, and reduced quality of generated summaries or documents.

Moreover, many known systems do not incorporate continuous learning from accumulated logs in a way that improves both behavior pattern recognition and emotion estimation specific to each user. They often rely on static models that are not incrementally updated based on newly recorded activity data, and they do not maintain user-specific temporal histories as structured learning corpora. This limits the system's ability to adapt to evolving work habits, application usage patterns, and domain-specific behaviors, thereby constraining the technical performance of the generative AI model when operating as a backend for automated report generation.

Also, emotional aspects of user interaction are generally handled, if at all, in a superficial or decoupled manner. Existing systems may apply generic sentiment analysis to arbitrary user text but typically do not combine emotion estimation from activity logs, display contents, and prompt sentences in an integrated server-side pipeline that feeds back into the generation of summaries or documents. Without this integrated approach, the generated outputs may lack sensitivity to user mood or stress levels, leading to suboptimal user experience and undermining the usefulness of the system in contexts where tone, level of detail, and emphasis should be dynamically adapted.

In summary, there is a need for a computer-implemented system that technically improves how user activity data is captured, normalized, structured, indexed, and supplied to a generative AI model, and that uses prompt sentences, behavior pattern learning, and emotion estimation in an integrated, server-centric architecture. Such a system should efficiently transform heterogeneous, time-series activity data into model-ready representations, support precise retrieval and preprocessing based on natural-language prompts, continuously refine user-specific models, and dynamically adjust generated content in accordance with the user's emotional state, thereby improving the technical functioning of the overall computer system.

The specific processing by the specific processing unit 290 of the data processing device 12 in Example 1 is realized by the following means.

The present invention provides a server comprising a processor and a storage subsystem, the processor being configured to receive, from one or more information processing terminals, structured operation logs and display contents that have been generated on the terminals by monitoring user input operations and instruction operations together with associated screen information, validate and normalize data items within the received logs including application identifiers, document identifiers, and network resource identifiers, index and store the normalized data as accumulated work session data in the storage subsystem on the basis of at least user identifiers, time information, and application types, receive request information including a natural-language prompt sentence from a user, parse the prompt sentence to determine time conditions and content conditions, retrieve, from the accumulated work session data, relevant chronological work session records satisfying the determined conditions, preprocess the retrieved records into model input data structured as a chronological work history with grouped activities, input the prompt sentence and the model input data into a generative AI model hosted by the server or accessible via a network interface, cause the generative AI model to generate a summary text or document text describing work contents of the user based on learned behavior patterns and the prompt sentence, perform an emotion analysis process using text information derived from the operation logs, the display contents, and the prompt sentence to estimate an emotional state of the user, adjust an expression format and emphasis portions of the generated summary text or document text according to the estimated emotional state, and transmit the adjusted summary text or document text to the user terminal for presentation. This enables the server-centric computer system to convert heterogeneous, time-ordered activity data into normalized and context-linked work session representations optimized for generative processing, to efficiently filter and structure such representations in direct response to user prompt sentences, to continuously refine behavior and emotion models per user, and to provide dynamically tailored summaries and documents that improve both the accuracy and responsiveness of the underlying computing architecture.

The term “information processing terminal” refers to an electronic computing device operated by a user, including at least a processor, a memory, an input interface, and a display interface, and configured to execute application programs, receive user input operations, and present screen information.

The term “user” refers to a human operator who interacts with an information processing terminal by performing input operations, issuing instructions, and providing prompt sentences.

The term “input operation” refers to an action performed by a user through an input interface of an information processing terminal, including at least keyboard input, pointing device input, touch input, or gesture input.

The term “instruction operation” refers to a user action that causes an information processing terminal to execute a command or function, including at least menu selection, button activation, application launch, or window switching.

The term “operation log” refers to structured data representing a history of input operations and instruction operations performed by a user on an information processing terminal, including at least time information, application-related information, and operation type information.

The term “display contents” refers to information presented on a display interface of an information processing terminal, including at least window titles, document titles, application screens, and identifiers of network resources being displayed.

The term “structured data” refers to data represented in a predefined schema including explicit fields such as time information, application type, window identifier, and document identifier, in a format suitable for machine processing and querying.

The term “time information” refers to data indicating a temporal attribute of an operation or display event, including at least a timestamp or a time range associated with the event.

The term “execution application type” refers to information indicating a category or kind of application program being executed on an information processing terminal, such as a browser-type application, a document-editing-type application, or a communication-type application.

The term “window identifier” refers to data that uniquely or quasi-uniquely identifies a graphical window instance on an information processing terminal, including at least a system-assigned window handle or an internal window ID.

The term “document identifier” refers to data that identifies a digital document associated with an application, including at least a file name, a document title, a document path, or a unique document ID assigned by an application or storage system.

The term “work context” refers to a logical unit of user activity associated with at least one application, window, or document, defined based on a correspondence between input operations and display contents over a time interval.

The term “context identifier” refers to data assigned to a work context for associating a plurality of operation logs and display contents that belong to the same work context, enabling grouping and retrieval of related activity.

The term “work session data” refers to a collection of operation logs and display contents that have been associated with context identifiers and arranged in chronological order to represent one or more continuous or related work contexts.

The term “predetermined threshold” refers to a condition defined in advance for dividing work session data into segments, including at least a size threshold, a time interval threshold, or an event count threshold.

The term “log data packet” refers to a unit of data generated by dividing work session data in accordance with a predetermined threshold, and including user identification information, time range information, and structured operation and display data, suitable for transmission over a communication network.

The term “communication network” refers to a wired or wireless digital communication infrastructure, including at least a local area network, a wide area network, or the Internet, used for data exchange between information processing terminals and a server.

The term “server” refers to an electronic computing system including at least one processor and at least one storage subsystem, configured to receive, store, process, and transmit data related to operation logs, display contents, and generated texts.

The term “validation” refers to processing that checks received data for correctness and integrity, including at least format verification, schema checking, and authentication or authorization checks.

The term “normalization” refers to processing that converts heterogeneous data items into a canonical representation, including at least standardizing application names, document identifiers, and network resource identifiers.

The term “application name” refers to a label or identifier representing a software application executed on an information processing terminal, which may be normalized into a canonical application identifier.

The term “document identification information” refers to data used to identify a document across different contexts, including at least a normalized document title, a logical document ID, or a storage path representation.

The term “network resource identification information” refers to data that identifies a resource accessible via a network, including at least a uniform resource locator or a resource path used in a network protocol.

The term “accumulated data storage device” refers to a storage subsystem, including at least a non-volatile memory or a disk-based storage medium, managed by the server for persistently storing normalized operation logs, display contents, and work session data.

The term “indexing” refers to organizing stored data in the accumulated data storage device by creating data structures that allow efficient retrieval based on keys such as user identifiers, time information, and application types.

The term “request information” refers to data transmitted from an information processing terminal to the server, including at least a prompt sentence, user identification information, and optional parameters indicating conditions for retrieval or generation.

The term “prompt sentence” refers to a natural-language input provided by a user, specifying at least a request for a summary or document generation and optionally including time conditions, content conditions, or formatting preferences.

The term “time conditions” refers to constraints derived from a prompt sentence or predefined parameters that specify one or more time ranges for which work session data is to be retrieved.

The term “content conditions” refers to constraints derived from a prompt sentence or predefined parameters that specify topics, applications, documents, or other content-related criteria for selecting work session data.

The term “model input data” refers to data prepared by the server for input to a generative AI model, including at least preprocessed, chronological work history and grouped activities derived from work session data.

The term “chronological work history” refers to a representation of user activities ordered by time, describing sequences of operations, applications used, documents edited, and network resources accessed.

The term “grouped activities” refers to sets of related operations and display events that are aggregated into higher-level units based on similarity in context, time proximity, or shared application or document identifiers.

The term “generative AI model” refers to a machine learning model capable of generating natural-language text or other output data by processing input sequences, including at least a neural network-based language model.

The term “behavior pattern” refers to a model of recurrent or characteristic user activity sequences inferred from work session data, including typical application usage flows, document editing patterns, and browsing behaviors.

The term “summary text” refers to a natural-language text output generated by the generative AI model that concisely describes work contents or activities of a user over a specified period or context.

The term “document text” refers to a natural-language text output generated by the generative AI model that is structured as a report, memorandum, or other formal document describing work contents or activities.

The term “emotion analysis processing” refers to computation that estimates an emotional state of a user by analyzing text information derived from operation logs, display contents, and prompt sentences using linguistic or statistical methods.

The term “emotional state” refers to a state of a user's affect or mood, such as stress, satisfaction, frustration, or motivation, inferred by emotion analysis processing from activity-related and textual data.

The term “expression format” refers to stylistic attributes of generated text, including at least tone, politeness level, degree of formality, and level of detail.

The term “emphasis portions” refers to parts of generated text that are highlighted or elaborated relative to other parts, such as key tasks, important findings, or critical issues.

The term “update learning” refers to processing in which a generative AI model or an associated model is trained or fine-tuned repeatedly or incrementally using newly accumulated operation logs and display contents to improve estimation accuracy over time.

The term “specific period” refers to a defined time range within the accumulated work session data, such as a particular day, work shift, or arbitrary time interval designated by a user or a prompt sentence.

The term “specific work context” refers to a subset of work session data that corresponds to one or more particular applications, windows, or documents, identified by context identifiers or content conditions.

The term “specific subject” refers to a topic or theme designated by a user or inferred from a prompt sentence, used to select and focus on related work session data and to constrain generated text.

In one embodiment, the system includes at least one server and one or more terminals interconnected via a communication network. The server includes a multi-core central processing unit, a volatile memory, and a non-volatile storage subsystem such as a solid-state drive or magnetic disk device. The terminal includes a processor, a memory, an input device such as a keyboard or pointing device, and a display device. The terminal executes an operating system, for example, a desktop operating system, and one or more application programs, for example, a browser-type application and a document-editing-type application.

The terminal executes a dedicated client program for capturing user operations. The terminal uses operating system APIs, such as low-level input hooks and window management interfaces, to intercept keyboard events, pointing device events, and window focus changes generated by the user. The terminal converts the intercepted events into structured operation records including a timestamp, an application process identifier, a window identifier, and an operation type. The terminal also queries the currently active window and associated document metadata, such as a document title or a file path, from the operating system. When the active application is a browser-type application, the terminal acquires a network resource identifier, such as a URL and a page title, via a browser extension interface or a remote debugging protocol.

The terminal generates a unified structured data object for each observed event. The terminal stores, in this data object, both the input-side information (for example, key code, button type, shortcut combination) and the display-side information (for example, window title, document identifier, network resource identifier). The terminal stores these objects temporarily in an in-memory buffer and additionally writes them to a local log file as a fault-tolerant mechanism.

The terminal assigns a context identifier to each sequence of events that occur within a continuous period in which the same window and document remain active. The terminal updates the context identifier when the user switches to another window, opens a new document, or navigates to a different network resource. The terminal thereby generates work context groupings directly at the data acquisition stage. This grouping reduces the computational cost of later server-side session reconstruction and improves the consistency of context boundaries independent of delayed or missing events.

The terminal divides locally accumulated logs into log data packets when a predetermined threshold is reached, such as a fixed time interval or a file size limit. The terminal attaches a device identifier, a user identifier, and a time range for each packet. The terminal compresses the packet if necessary and transmits it to the server using an encrypted transport protocol over the communication network. The terminal uses a retry mechanism and acknowledgement tracking to ensure reliable delivery. Because the terminal performs pre-grouping and packetization, the communication load is reduced and the server receives data in a format that is already partially ordered and segmented for efficient processing. The server receives log data packets via a network interface and passes the packets to an ingestion module. The server validates each packet by checking a message authentication code or a digital signature, and by verifying that the internal schema of the data objects matches an expected definition. The server discards invalid records or marks them for separate error handling. The server then performs a normalization process on valid records. In this process, the server maps raw application process names to canonical application categories, such as browser-type, document-editing-type, or communication-type. The server also normalizes document identifiers by transforming raw file paths or transient window titles into stable identifiers, using a dictionary or a hash-based mapping. For network resource identifiers, the server strips tracking parameters and canonicalizes host names and path segments.

The server stores the normalized records in a database system. The server organizes data in tables or collections partitioned by user identifier and time range. The server creates indexes on at least the user identifier, timestamp, application category, document identifier, and network resource identifier. The server also maintains secondary structures, such as inverted indexes for textual fields, to support later retrieval by keywords or topics. By storing data in an index-optimized structure, the server can retrieve a specific user's chronological work session for an arbitrary day or time window in sub-linear time relative to the total log volume. The server executes a generative AI engine for processing work session data and generating summary texts or document texts. In one embodiment, the generative AI engine includes a neural network of the transformer type. The network has multiple layers of self-attention blocks and feed-forward units, trained on tokenized text sequences. The server uses a tokenizer that converts textual data fields—such as document titles, network resource titles, and previously generated summaries—into token sequences. The server represents non-textual metadata, such as application category or operation type, as special tokens or embedding vectors. By encoding both content data and metadata as a unified token sequence, the generative AI engine can learn and exploit correlations between patterns of operations and semantic content of documents.

The server uses a training process in which the generative AI model receives, as input, sequences describing user activities and associated narrative descriptions. The server defines a loss function such as a cross-entropy loss over next-token prediction for the target narrative. The server updates the model parameters by gradient descent using a stochastic optimizer such as an adaptive learning rate algorithm. In an update learning mode, the server periodically fine-tunes the model using newly accumulated work session data for each user or for a group of users. The server thus adapts the model to user-specific behavior patterns, such as characteristic sequences of opening a browser, visiting certain categories of network resources, and editing specific document types.

The server also executes a separate or integrated emotion analysis module. In one embodiment, the emotion analysis module is another neural network that receives, as input, a concatenation of textual information derived from operation logs and display contents, such as document titles and network resource titles, together with the prompt sentence provided by the user. The emotion analysis module outputs a probability distribution over a set of emotional categories, such as “neutral,” “stressed,” or “confident.” The server computes an emotion loss function during training by comparing the predicted distribution with labeled or pseudo-labeled emotion indicators and updates the model weights accordingly. This explicit formulation of an emotion estimation problem as a supervised or semi-supervised learning task improves the reproducibility and stability of the emotional state estimation. The server implements a data flow in which multiple specialized modules are connected: an ingestion and normalization module, a session reconstruction and aggregation module, a generative AI interface module, and an emotion analysis module. The server uses defined intermediate data structures, such as a “session timeline object,” which stores for each time segment the application category, document identifier, network resource identifier, summary of operations, and associated context identifier. The server converts each session timeline object into a structured model input data object that can be serialized as text segments for input to the generative AI model.

The server receives a prompt sentence from the terminal. The user inputs the prompt sentence through a user interface on the terminal. For example, the user may enter:
“Summarize my work activities from 9:00 a.m. to 6:00 p.m. yesterday, focusing on the research I did in the web browser and the report I wrote.”
   or
“Generate a formal report based on yesterday's operations, including an introduction, three main sections summarizing my browser research, and a conclusion suitable for presentation to management.”
   or
“From last week's work logs, extract and summarize only the activities related to the ‘Project Alpha’ proposal, and list the main sources I referenced.”

The terminal transmits the prompt sentence together with user identification information and optional explicit time conditions to the server. The server parses the prompt sentence using a natural language understanding module, which may be a rule-based parser or a separate neural model. The server extracts time conditions, such as “yesterday” and “9:00 a.m. to 6:00 p.m.,” and content conditions, such as “research in the web browser” or “activities related to the proposal.” The server transforms natural-language expressions into normalized query parameters. For example, “yesterday” is resolved into a specific calendar date based on the server's time zone.

The server then queries the database using the extracted parameters. The server selects only those session records that fall within the specified time range and satisfy the content conditions, for example, sessions where the application category is browser-type and the document or network resource identifiers contain certain keywords. The server brings the selected records into memory and orders them strictly by timestamp. The server further aggregates short gaps or bursts of activity into larger intervals if they satisfy a temporal proximity rule, such as merging segments that are separated by less than a predefined idle interval. This aggregation reduces the number of segments and simplifies the sequence that the generative AI engine must process, thereby improving computational efficiency.

The server transforms each aggregated interval into a compact textual description, such as “From 09:10 to 09:35, the user visited the following network resources: [list of normalized resource titles] and copied content into a document identified as [document identifier].” The server also encodes metadata, such as application categories and context identifiers, into special annotation tokens. The server concatenates these descriptions into a sequence that forms the chronological work history. The server attaches the user's prompt sentence at the beginning of the sequence as a special instruction segment.

The server then invokes the generative AI model with the combined instruction and context sequence. Because the server has pre-filtered and pre-aggregated the data into a condensed, context-aware format, the model can operate on fewer tokens while still having access to all relevant information. This reduces the computational load per request and minimizes latency. The model uses its learned attention mechanisms to focus on segments that relate to the specified content conditions, such as browser research or a specific subject, and generates a summary text or document text that follows the structure implied by the prompt sentence, for example, an introduction followed by main sections and a conclusion.

The server also invokes the emotion analysis module for the same sequence, focusing on the textual cues of stress or emphasis in document titles, network resource titles, and the wording of the prompt sentence. The server obtains an estimated emotional state and adjusts the generative parameters accordingly. For instance, when the emotional state indicates stress, the server may request a more concise, action-oriented summary with simplified language. When the emotional state indicates a neutral or exploratory state, the server may allow a more detailed, descriptive report. The server may modify the model temperature parameter, the target length, or the presence of specific templates to implement this adjustment. The server outputs the generated text as a data object containing both the raw generated sequence and metadata such as the time range, the applied filters, and the estimated emotional state. The server stores this object in the storage subsystem for audit and re-use. The server transmits the generated text and metadata to the terminal. The terminal receives the response and renders the text in a display region. The user can read, scroll, copy, or save the generated text. The terminal may also provide buttons for refining the request, such as “focus more on competitive analysis” or “shorten the summary,” which send additional prompt sentences to the server referencing the previously generated document.

This architecture produces several technical effects beyond mere automation of human summarization. By combining terminal-side structured logging, context-based grouping, and server-side normalization and indexing, the system reduces data redundancy and ensures that the generative AI engine receives only context-relevant, chronologically consistent data. This leads to more accurate and stable model outputs for a given computational budget. The use of transformer-based models with explicit encoding of application categories, document identifiers, and time segments enables the system to capture long-range dependencies in user behavior that are difficult for rule-based or simpler models to represent.

The server's pre-aggregation of events into session timeline objects and the conversion into compact, annotated text reduces the number of tokens required for each generation, which directly improves processing speed and reduces memory utilization. The continuous update learning using newly accumulated work session data allows the system to adapt to changing usage patterns and to correct systematic errors in behavior pattern recognition and emotion estimation, thereby reducing error rates over time.

The system uses technical mechanisms that are not simply equivalent to human reasoning, such as embedding numerical representations of application categories and time intervals into a high-dimensional vector space and applying self-attention weighted by learned parameters over entire sequences of user activity. These mechanisms allow the model to relate distant events in a way that humans would find difficult without explicit notes or timelines. The emotion analysis module uses specific feature sets, including frequency of certain operation types, such as rapid window switching or repeated undo operations, as additional signals for estimating stress or confusion. By combining such non-obvious signals with textual analysis, the system achieves a more robust and technically grounded estimate of the user's emotional state.

The technical improvement is realized in multiple aspects: the data management is improved by normalization and indexing tailored to time-series work session data; the processing efficiency is improved by terminal-side context grouping and server-side aggregation before model invocation; the generation accuracy is improved by conditioning on structured representations of behavior patterns and emotional state; and the communication overhead is reduced by sending compressed, pre-structured log packets instead of raw event streams. These improvements are implemented through specific data structures, such as context identifiers, session timeline objects, and annotated text sequences, and through algorithmic flows involving validation, normalization, grouping, indexing, and model-based generation and adjustment.

In alternative embodiments, the server may implement different model architectures, such as recurrent neural networks or hybrid models combining rule-based components and neural components, but the core concept of using structured, context-linked work session data as model input and dynamically adjusting generated text based on an estimated emotional state remains the same. In other embodiments, the terminal may be a mobile computing device or a thin client, and the server may be a distributed cluster of machines, but the functional partitioning between terminal-side logging and server-side processing is preserved. Through these variations, the system remains directed to improving computer technology itself, by optimizing how heterogeneous user activity data is captured, stored, retrieved, and transformed into useful, context-aware outputs by a generative AI model in a technically efficient and scalable manner.

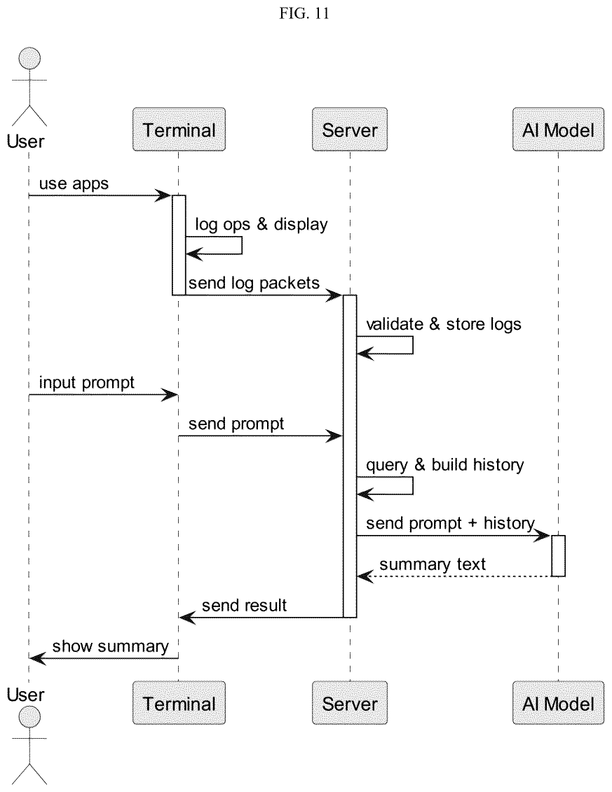

The following describes the processing flow using FIG. 11.
Step 1:

The terminal initializes a logging environment.

The terminal receives, as input, configuration data including a user identifier, logging interval, and thresholds for packetization. The terminal loads this configuration from a local file or from the server. The terminal registers low-level input hooks with the operating system to intercept keyboard events and pointing device events, and registers callbacks with the window management subsystem to detect window focus changes. The terminal allocates an in-memory buffer and opens a local log file. The terminal outputs an initialized logging state, including active hooks, an empty buffer, and a ready log file descriptor.
Step 2:

The terminal captures raw input operations.

The terminal receives, as input, raw events from the operating system, such as key-down, key-up, mouse-move, mouse-click, and shortcut combinations. The terminal reads event attributes, including key codes, button codes, cursor positions, and event timestamps. The terminal converts these attributes into structured operation records by mapping each event to fields: timestamp, user identifier, process identifier of the active application, window identifier, and operation type. The terminal appends these records to the in-memory buffer and periodically flushes the buffer to the local log file. The terminal outputs a time-ordered sequence of structured operation records.
Step 3:

The terminal captures display information.

The terminal receives, as input, the current state of the graphical user interface from the operating system, including the active window handle and a list of open windows. The terminal queries each active window for metadata such as window title, application name, and, when available, document title or file path. When the active application is a browser-type application, the terminal invokes a browser interface to obtain the current tab's URL and page title. The terminal formats these attributes into structured display records containing a timestamp, application category, window identifier, document identifier, and network resource identifier. The terminal outputs display records that can be associated with operation records.
Step 4:

The terminal associates operations with display contexts.

The terminal receives, as input, the structured operation records and the display records generated in Steps 2 and 3. The terminal maintains a current context identifier per active window or document. For each operation record, the terminal finds the most recent display record for the same window identifier and assigns the corresponding context identifier. When the user switches windows, opens a new document, or navigates to a new URL, the terminal generates a new context identifier and links it to subsequent operation and display records. The terminal outputs combined records that include operation fields, display fields, and a context identifier, forming initial work context data.
Step 5:

The terminal segments logs into data packets.

The terminal receives, as input, a stream of combined records and monitors buffer size and elapsed time. When a predetermined threshold is exceeded, the terminal groups the combined records into a segment defined by a time range. The terminal adds metadata such as user identifier, device identifier, and time interval boundaries to the segment. If configured, the terminal compresses the segment using a data compression routine. The terminal formats the segment into a log data packet ready for transmission. The terminal outputs a set of log data packets, each representing a portion of work session data.
Step 6:

The terminal transmits log data packets to the server.

The terminal receives, as input, the prepared log data packets and the address of the server.

The terminal opens a secure network connection using a transport protocol, attaches authentication credentials, and sends each packet to a designated upload endpoint. The terminal waits for an acknowledgment from the server; upon successful receipt, the terminal marks the corresponding local data as uploaded and may delete or archive it. The terminal outputs a transmission status indicating which packets were successfully delivered and which require retry.
Step 7:

The server receives and validates log data packets.

The server receives, as input, incoming packets from multiple terminals via a network interface. The server authenticates each packet by verifying tokens or signatures and checks the integrity of the payload using checksums or hashes. The server deserializes the payload into internal data structures representing combined records. The server validates that mandatory fields such as timestamp, user identifier, application name, and context identifier are present and well-formed. The server outputs a set of valid combined records and a separate list of invalid or corrupted records for error handling.
Step 8:

The server normalizes application, document, and network identifiers.

The server receives, as input, the valid combined records from Step 7. The server applies a mapping table or normalization rules to convert raw application names into canonical application categories, to convert document titles or file paths into stable document identifiers, and to canonicalize network resource identifiers by removing tracking parameters and standardizing host and path formats. The server updates each combined record with normalized values and may add derived attributes such as application category codes. The server outputs normalized records that share a consistent schema across users and terminals.
Step 9:

The server indexes and stores work session data.

The server receives, as input, the normalized records from Step 8. The server groups records by user identifier and sorts them by timestamp if needed. The server inserts the records into database tables or collections partitioned by user and time period. At insertion, the server builds or updates indexes on keys including user identifier, timestamp, application category, document identifier, network resource identifier, and context identifier. The server may also create aggregated statistics for each session, such as session duration or operation counts. The server outputs persisted work session data stored in an accumulated data storage device with corresponding index structures.
Step 10:

The user enters a prompt sentence for generation.

The user receives, as input, a graphical interface on the terminal showing a text input field and optional parameter controls. The user types a prompt sentence such as “Summarize my work activities from 9:00 a.m. to 6:00 p.m. yesterday, focusing on the research I did in the web browser and the report I wrote.” and submits it. The terminal captures the prompt sentence along with user identifier and, optionally, explicit time range selections made via the interface. The terminal outputs a request object containing the prompt sentence and associated parameters and sends this object to the server.
Step 11:

The server interprets the prompt sentence and derives conditions.

The server receives, as input, the request object from the terminal. The server applies a parsing module to the prompt sentence, using pattern rules or a lightweight language model, to identify temporal expressions (“yesterday,” “from 9:00 a.m. to 6:00 p.m.”) and topical expressions (“research in the web browser,” “report I wrote,” or a project name). The server converts temporal expressions into concrete time ranges based on the server's clock and time zone and converts topical expressions into filters on application categories, document identifiers, or keywords. The server outputs retrieval conditions including user identifier, time range, application filters, and content filters.
Step 12:

The server retrieves relevant work session data from storage.

The server receives, as input, the retrieval conditions from Step 11. The server constructs one or more database queries using the user identifier, time range, and filters on application categories, document identifiers, or network resource identifiers. The server executes these queries and obtains a set of normalized records representing operations and display events that meet the conditions. The server orders the retrieved records chronologically and groups records into segments based on context identifiers and temporal proximity rules, such as merging records that are contiguous in time within a predefined idle threshold. The server outputs grouped session segments that correspond to coherent work intervals.
Step 13:

The server constructs a chronological work history and grouped activities.

The server receives, as input, the grouped session segments from Step 12. For each segment, the server summarizes the operations and associated resources, such as listing document identifiers edited, network resources accessed, and main operation types performed. The server formats each segment into a textual description that includes start time, end time, application categories, and key artifacts. The server also attaches annotations or tags representing context identifiers and activity types. The server concatenates these descriptions in chronological order to form a chronological work history and organizes related descriptions into grouped activities. The server outputs model input data that includes the work history and grouped activities as structured text.
Step 14:

The server prepares combined input for the generative AI model.

The server receives, as input, the model input data and the original prompt sentence. The server constructs a combined sequence by placing the prompt sentence at the beginning as an instruction, followed by the chronological work history and grouped activity descriptions, each separated by special markers. The server then tokenizes this sequence using a tokenizer associated with the generative AI model, converting characters and words into token IDs. The server embeds metadata, such as application categories and time boundaries, as special tokens or features. The server outputs a token sequence suitable for processing by the generative AI model.
Step 15:

The server estimates the user's emotional state.

The server receives, as input, text fields derived from operation logs and display contents, such as document titles and network resource titles, together with the prompt sentence and, optionally, statistical features of the user's operations, such as rapid window switching frequency. The server passes these features to an emotion analysis model, which computes feature representations and outputs a probability distribution over predefined emotional categories. The server evaluates this distribution to determine a predominant emotional state. The server outputs the estimated emotional state and associated confidence values to be used in generation control.
Step 16:

The server generates a summary or document text using the generative AI model.

The server receives, as input, the token sequence from Step 14 and the estimated emotional state from Step 15. The server passes the token sequence through the generative AI model, which applies layers of attention and transformation to compute context-aware representations for each token. The server uses the model to iteratively predict next tokens, subject to constraints on maximum length and style, and adjusts generation parameters such as temperature, beam width, or template selection based on the emotional state and any format requirements from the prompt. The server decodes the generated token sequence back into a natural-language text. The server outputs a raw generated text that describes the user's work contents in accordance with the prompt sentence.
Step 17:

The server adjusts and formats the generated text.

The server receives, as input, the raw generated text from Step 16 and the estimated emotional state from Step 15. The server applies post-processing rules to refine the text, such as inserting section headings, ensuring that time ranges and key activities are explicitly mentioned, and simplifying or elaborating sentences according to the emotional state. The server may check the text against the retrieved session data to confirm that referenced documents or network resources exist, and may correct inconsistencies. The server formats the adjusted text into a representation suitable for delivery, such as plain text, marked-up text, or a structured document. The server outputs a finalized summary text or document text along with metadata describing the generation conditions.
Step 18:

The server transmits the generated result to the terminal.

The server receives, as input, the finalized text and metadata from Step 17 and the destination information for the user's terminal. The server encapsulates the text and metadata into a response message and sends it over the communication network using a response protocol. The server may also store a copy of the generated result for future reference. The server outputs a transmission confirmation when the terminal acknowledges receipt.
Step 19:

The terminal presents the generated result to the user.

The terminal receives, as input, the response message containing the finalized text and metadata from the server. The terminal parses the message and extracts the summary or document text and any associated information such as the covered time range and applied filters. The terminal renders the text in a display area, allowing scrolling, selection, and saving. The terminal may also generate user interface elements for refinement, such as buttons that, when activated, capture new prompt sentences referencing the current result. The terminal outputs an updated user interface state in which the user can review and further interact with the generated content.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems that log user operations or machine operations typically focus on narrow analytics such as simple counting of events, coarse-grained performance dashboards, or static rule-based alerts. These systems generally treat user operation logs, display contents, and machine work logs as separate data streams, and therefore fail to exploit their combined temporal structure. As a result, it is difficult to automatically generate high-quality, context-aware summaries of user business activities or to derive actionable optimization proposals for machine work processes.

In particular, existing computer-implemented log analysis systems suffer from several technical limitations. First, event logs and display contents are often stored as unstructured or loosely structured records, without systematic grouping into coherent time-series units such as user work sessions or machine work cycles. This makes it technically complex and computationally inefficient to apply advanced sequence models, and typically requires substantial manual preprocessing or ad-hoc scripts. Second, generative AI models, when used at all, are usually invoked in an isolated manner on ad-hoc prompts, without being fine-tuned on the underlying time-ordered operation histories and without integrating computed efficiency metrics from machine logs. Such usage prevents the model from learning behavior patterns and work patterns that are specific to the user and to the machine apparatus, and thus degrades the relevance and reliability of generated summaries and proposals.

Furthermore, conventional systems rarely incorporate dynamic prompt construction that combines user inquiries, session-level meta information, machine efficiency indices, and emotion analysis results. Without such structured prompt design, the generative AI model cannot be effectively conditioned on the detailed computational context of the logs, leading to generic or misaligned outputs. In addition, emotion analysis, when present, is typically applied only to user messages and is not used in a feedback loop to systematically adjust the expression content and level of detail of generated summaries and optimization proposals. This prevents the system from adapting the granularity and tone of outputs to the user's current cognitive state, thereby reducing usability and effectiveness.

From a computer-technology perspective, there is a need for a computer-implemented technique that: (i) normalizes, denoises, and groups heterogeneous log data into coherent time-series units suitable for machine learning; (ii) constructs structured text sequences and training datasets from these units; (iii) fine-tunes a generative AI model so that a single model can produce both user-activity summaries and machine-efficiency explanations; and (iv) dynamically assembles prompt sentences with quantitative indices and emotion analysis results to generate context-aware, user-adaptive outputs. Without such an integrated architecture, it is difficult to efficiently utilize computational resources, to maintain consistency between analysis results and generated natural-language outputs, and to improve the technical performance of log-analysis and report-generation systems running on general-purpose computing hardware.

The specific processing by the specific processing unit 290 of the data processing device 12 in Application Example 1 is realized by the following means.

The present invention provides a server comprising a processor configured to acquire operation history information and display information or work information from an information processing apparatus of a user and from a machine apparatus, arrange the acquired information in chronological order, remove noise from the arranged information, group the chronologically arranged information on a session basis or on a work-cycle basis, and convert the grouped information for each session or each work cycle into a text sequence; to convert the text sequence into a token sequence, train or update a generative AI model by using the token sequence, and model a behavior pattern of the user and a work pattern of the machine apparatus by using the generative AI model; to input, to the generative AI model, an input sentence including a prompt sentence automatically generated by the server and a prompt sentence received from the user, together with time-series information associated with the session or the work cycle, and generate summary information or document information regarding business content of the user and analysis information regarding a work process of the machine apparatus; to calculate a work-efficiency index on the basis of the analysis information, generate an improvement proposal or an optimization proposal for the work process of the machine apparatus according to the work-efficiency index, and generate the improvement proposal or the optimization proposal in a natural-language form by using the generative AI model; to analyze an emotion of the user and, on the basis of the analyzed emotion, adjust an expression content or a detail level of the summary information, the document information, and the improvement proposal or the optimization proposal; and to output the summary information, the document information, and the improvement proposal or the optimization proposal to a user terminal. This enables the server to technically improve computer-implemented log analysis and report generation by transforming heterogeneous event streams into structured time-series training data for a single generative AI model, by performing integrated computation of work-efficiency indices and emotion-aware prompt conditioning, and by thereby generating context-consistent, user-adaptive natural-language outputs that enhance processing efficiency and effectiveness on general-purpose computing resources.

The term “operation history information” refers to data representing chronological records of actions performed by a user or a machine, including but not limited to input events, command executions, state transitions, and other operation events observable by a computing device.

The term “display information” refers to data representing content that is presented on a display unit of an information processing apparatus, including but not limited to textual content, graphical content, and layout information that can be captured or reconstructed by software.

The term “work information” refers to data representing execution states, tasks, or processes performed by a machine apparatus, including but not limited to position information, operation states, task identifiers, cycle identifiers, loads, and timestamps associated with such tasks or processes.

The term “information processing apparatus” refers to an electronic device that performs data input, data processing, and data output by executing software, including but not limited to computers, terminals, and other programmable digital devices.

The term “machine apparatus” refers to a mechanical or electromechanical device configured to perform a work task, including but not limited to industrial machines, robots, production equipment, and automated handling devices.

The term “chronological order” refers to an arrangement of data elements according to their associated time information so that earlier events precede later events in a sequence.

The term “noise” refers to information included in operation history information, display information, or work information that is irrelevant, redundant, or erroneous for a target analysis or modeling process, and that is therefore preferably removed or reduced.

The term “session” refers to a contiguous time period or logical unit of user activity that is grouped based on operation history information and display information, typically separated from another session by an idle period or a predefined condition.

The term “work cycle” refers to a single instance of a repeated work process performed by a machine apparatus, defined by a start condition and an end condition and including a sequence of work steps or states.

The term “text sequence” refers to an ordered series of textual elements, such as words, symbols, and delimiters, generated from grouped operation history information, display information, or work information so as to be suitable for natural language processing.

The term “token sequence” refers to an ordered series of discrete symbols or indices obtained by applying a tokenization process to a text sequence, where each token represents a unit such as a word, subword, or character.

The term “generative AI model” refers to a machine learning model configured to generate data, including but not limited to natural-language text, by predicting subsequent elements based on input elements, and typically implemented using a neural network such as a sequence model or a transformer model.

The term “behavior pattern” refers to a representation of recurring tendencies or structures in user actions over time, derived from operation history information and display information and modeled by the generative AI model.

The term “work pattern” refers to a representation of recurring tendencies or structures in machine operations over time, derived from work information and modeled by the generative AI model.

The term “input sentence” refers to a sequence of textual elements supplied to the generative AI model as input, including at least one prompt sentence and optionally additional contextual text.

The term “prompt sentence” refers to a sentence or set of sentences that instructs or conditions the generative AI model regarding a desired task, style, content, or output format.

The term “time-series information” refers to data that associates values or events with corresponding time points or intervals, enabling representation and analysis of temporal order and temporal dependencies.

The term “summary information” refers to natural-language text or structured text that condenses business content or work content into a shorter, essential representation while preserving important elements of meaning.

The term “document information” refers to natural-language text or formatted text generated for the purpose of reporting, documentation, or communication of business content, such as reports, explanations, or descriptions.

The term “analysis information” refers to data derived from computational processing of work information or operation history information, including but not limited to statistical results, identified patterns, and diagnostic indicators regarding a work process.

The term “work-efficiency index” refers to a quantitative or semi-quantitative metric representing efficiency of a work process, calculated from work information or analysis information and including, for example, cycle time, utilization ratio, or idle time ratio.

The term “improvement proposal” refers to content that recommends modifications to a work process or configuration with the aim of increasing efficiency, reliability, or quality, and that is generated in a natural-language form.

The term “optimization proposal” refers to content that recommends one or more candidate configurations or process changes evaluated to be more effective or efficient with respect to a defined work-efficiency index or other objective criteria.

The term “emotion of the user” refers to an inferred affective state of the user, such as stress, satisfaction, or confusion, estimated by analyzing user-related data, including but not limited to operation history information, textual input, or interaction patterns.

The term “expression content” refers to linguistic characteristics of generated text, including but not limited to wording, tone, style, and narrative structure used in summary information, document information, improvement proposals, or optimization proposals.

The term “detail level” refers to a degree of granularity or specificity of information included in generated outputs, such as the amount of step-by-step explanation, numerical detail, or technical depth.

The term “user terminal” refers to an information processing apparatus operated by a user for inputting data, receiving outputs from the server, and interacting with the system, including but not limited to personal computers, mobile terminals, and tablets.

In one embodiment, a server includes a processor, a memory, a storage device, and a communication interface. The server is connected via a network to one or more terminals operated by users and to one or more machine apparatuses such as industrial machines or robots. The server executes stored programs to perform acquisition, preprocessing, modeling, and generation operations as described below. The terminal includes at least a processor, a memory, an input device, a display device, and a communication interface, and executes a logging program and a user interface program.

The terminal captures operation history information and display information. The terminal runs a logging component implemented, for example, as an application that hooks operating system input events and window events. The terminal acquires keyboard events, pointing-device events, active window titles, and, in some embodiments, text rendered in foreground application windows. The terminal may call system APIs of an operating system to acquire these events. The terminal assigns a timestamp from a system clock to each event and stores the event into a local buffer using a structured event record. The terminal uses a generic data structure such as a key-value map or an object comprising at least an event type field, a timestamp field, an application identifier field, and one or more payload fields. The terminal periodically transmits buffered records to the server via the communication interface using a network protocol.

The server receives the operation history information and the display information from the terminal. The server stores the received information in a storage device, such as a relational data store or a key-value data store. The server converts incoming records into an internal normalized format. For example, the server normalizes timestamps into a unified time base and converts application identifiers and device identifiers into internal canonical identifiers. The server stores the normalized events into a time-ordered data structure, such as an append-only event table or a time-series index.

The server acquires work information from a machine apparatus. The server connects to the machine apparatus using an industrial communication protocol or a dedicated interface. The machine apparatus provides operation states, position readings, cycle identifiers, and other work information as a stream of messages. The server receives the messages and constructs structured records containing at least a timestamp, a machine identifier, a cycle identifier, an operation state code, and one or more numeric or categorical attributes such as position, velocity, or load. The server stores the work information into a time-series store separate from or integrated with the store used for user events.

The server performs noise removal and grouping of the collected data. The server applies algorithmic filtering to the operation history information, the display information, and the work information. For example, the server discards events occurring at intervals shorter than a predetermined threshold when such events are classified as spurious toggles, and the server merges consecutive identical states into a single longer state. The server groups user events into sessions and groups machine events into work cycles. The server determines a session boundary when an interval between user events exceeds an idle threshold or when a context change condition such as a switch of a primary application is detected. Similarly, the server determines a work-cycle boundary when a machine state transitions from an idle or complete state to a working state and then returns. By grouping events in this way, the server constructs compact time-series units that are suitable as input to sequence modeling algorithms. The server converts grouped data into text sequences. For each session, the server generates a text representation in a natural-language-like format that encodes crucial structure while compressing redundant details. The server uses templates and rule-based summarization to convert structured fields into textual statements. For example, the server may generate a sentence such as “At 09:15, the user opened a presentation document and edited slides on cost analysis; then, at 09:32, the user visited an online report and copied numerical data into the document.” For each work cycle, the server generates text such as “Cycle 1: the machine moved 5 meters without load, waited 4 seconds, picked up a 2 kilogram object, moved 5 meters with load, and placed the object on a conveyor.” This conversion produces text sequences that preserve ordering and key quantitative information while transforming internal structured data into a sequence form that can be processed efficiently by a generative AI model.

The server tokenizes the generated text sequences. The server applies a tokenizer that maps text to discrete token identifiers. In one embodiment, the tokenizer uses a subword segmentation algorithm. The server converts the text for each session or work cycle into a token sequence and constructs attention masks that indicate valid positions in each sequence. The server stores these token sequences as training examples, optionally together with target sequences representing desired summaries or explanations.

The server trains or fine-tunes a generative AI model using the token sequences. The server implements the generative AI model as a neural-network-based sequence model, for example a transformer architecture with multiple self-attention layers, feedforward layers, and normalization layers. The generative AI model receives as input a sequence of token identifiers and outputs a probability distribution over possible next tokens at each position. The server initializes the model either from random weights or from a pre-trained language model. The server configures an optimization procedure with a loss function such as cross-entropy loss between predicted tokens and target tokens, an optimizer such as a gradient-based optimizer, and hyperparameters including learning rate, batch size, and number of training iterations.

The server processes training batches by executing forward passes and backward passes through the generative AI model. In a forward pass, the server passes a batch of token sequences through the embedding layer, attention layers, and feedforward layers, producing output logits. The server applies the loss function to measure the discrepancy between the output logits and the target token identifiers. In a backward pass, the server computes gradients of the loss with respect to model parameters and updates the model parameters in the direction that reduces the loss. The server repeats this process across multiple epochs over the training dataset until convergence or until a termination criterion is satisfied. The server stores the resulting model parameters in the storage device.

The server uses the trained generative AI model to model behavior patterns and work patterns. The server interprets internal activations and learned parameters as capturing regularities in the sequences of user actions and machine operations. Because the training data is composed of denoised, grouped, and structurally encoded sequences, the model can learn long-range dependencies such as multi-step editing workflows or multi-step machine paths more accurately than when using raw logs. This improves the ability of the model to predict relevant tokens and reduces perplexity relative to models trained on unstructured event streams.

The user issues a prompt sentence via the terminal. The terminal presents a user interface that displays an input field for a prompt sentence and optional controls for selecting a time range or a machine. The user can enter a prompt sentence such as “Please summarize my work for this morning based on my operation logs and display contents.” or “Analyze the following factory robot operation logs and propose methods to improve work efficiency. Focus on reducing unnecessary movement and waiting time.” The terminal transmits the prompt sentence and associated context information including a user identifier, a time range, or a machine identifier to the server.

The server constructs an input sentence to the generative AI model. The server retrieves one or more sessions or work cycles corresponding to the context information. The server optionally compresses or selects events to meet a length constraint. The server then concatenates a system instruction segment, the session or work-cycle text sequence, and the prompt sentence into a single input sentence. In some embodiments, the server also inserts numeric summaries such as average cycle time or idle time. For example, the input sentence may include phrases such as “average cycle time: 45 seconds; movement without load: 40 percent of cycle time; waiting at pickup: 6 seconds on average.”

The server performs emotion analysis on user-related data. The server can apply a separate model or a dedicated submodule to estimate an emotional state of the user. For example, the server may analyze the variability of input speed, error frequency, or wording of prompt sentences and classify emotional states into categories such as “stressed,” “neutral,” or “confident.” The server stores an emotion label and an associated confidence score for recent sessions. The server uses the emotion label as a feature when constructing the input sentence, for example by inserting a phrase such as “the user appears to be under time pressure; please respond concisely.” This explicit conditioning enables the generative AI model to modulate the verbosity and tone of generated text.

The server executes inference of the generative AI model on the constructed input sentence.

The server tokenizes the input sentence and feeds the resulting token sequence into the generative AI model in inference mode. The server performs a forward computation and applies a decoding algorithm such as greedy decoding, beam search, or nucleus sampling to select output tokens step by step. The server stops generation when an end-of-sequence token or a length limit is reached. The server converts the sequence of output tokens back into text form. Depending on the prompt sentence and the context, the generated text can represent summary information describing user activities, document information structured as a report, analysis information describing bottlenecks in machine work, or improvement and optimization proposals for machine processes.

The server computes a work-efficiency index using the analysis information and the work information. The server calculates metrics such as mean cycle time, variance of cycle time, ratio of movement without load to total movement, and mean waiting time at particular states. The server uses deterministic arithmetic operations on the stored work information to compute these values. The server then combines the numeric metrics with the generated text by either embedding the metrics into an input sentence to refine the generative output or by attaching structured numeric tables to the textual description. This combined usage of numeric computation and sequence modeling enables the system to provide both measurable indices and narrative explanations.

The server generates improvement proposals and optimization proposals for the machine work process. The server uses the generative AI model to translate metrics and sample cycles into concrete recommendations, such as repositioning a machine, adjusting a path, or modifying scheduling parameters. The server may apply rules to post-process the generated text, for example to ensure that certain safety constraints are mentioned or to categorize proposals. Because the generative AI model has been trained on structured representations of work cycles and patterns, the proposals are not generic but consider specific temporal and quantitative characteristics of the recorded operations.

The server adjusts the expression content and detail level of outputs based on emotion analysis. If the emotion analysis indicates that the user is overloaded or under time pressure, the server may instruct the generative AI model to produce shorter summaries using fewer technical terms and to highlight only essential recommendations. If the emotion analysis indicates that the user seeks detailed technical information, the server may instruct the model to provide more granular explanation of metrics, intermediate steps, and trade-offs. This dynamic adjustment is implemented through modifications of the input sentence provided to the generative AI model, and thus directly influences the distribution over next tokens computed within the neural network.

The terminal receives and displays the output produced by the server. The terminal renders summary information, document information, and proposals in a form suitable for the user, such as a text viewer or a panel with sections. In some embodiments, the terminal allows the user to request additional refinement by entering further prompt sentences such as “Rewrite the optimization proposal as a step-by-step implementation plan for maintenance engineers” or “Generate a bullet-point checklist for my tasks tomorrow based on today's summary.” The terminal sends such prompt sentences with references to previous outputs back to the server, enabling iterative refinement without duplicating low-level log processing.

This configuration yields several technical effects. Because the server groups heterogeneous logs into sessions and work cycles before training, the generative AI model is provided with input sequences that more accurately reflect logical units of activity, which increases prediction accuracy and reduces training time relative to models trained on raw event streams. Because the server encodes numeric metrics and structural metadata as part of its input sentences, the generative AI model learns correlations between quantitative indices and narrative descriptions, allowing the model to generate analyses and proposals that are consistent with computed metrics. Because the server uses structured tokens, attention masks, and a transformer architecture with explicit handling of long time-series, the system improves the computational efficiency of both training and inference, for example by reducing unnecessary padding and enabling parallelization within attention layers.

Moreover, the server improves computer technology by providing an integrated pipeline from low-level event capture to high-level sequence modeling and output, with explicit data structures and algorithms that minimize memory usage and network load. The terminal transmits only pre-structured event records, not full video streams, which reduces communication bandwidth requirements. The server performs noise removal and grouping before model inference, which reduces the number of tokens necessary to represent a given time range, thereby decreasing computation time and power consumption during training and inference. The combination of deterministic metric computation and neural sequence modeling enables the server to deliver higher accuracy in identifying inefficiencies and higher relevance in generated proposals than rule-based or purely manual analysis, due to the model's ability to capture nonlinear patterns across long sequences.

In alternative embodiments, the server may employ different neural-network architectures, such as recurrent neural networks or hybrid transformer-convolutional networks, as long as the model can process token sequences and produce next-token probabilities. The server may also vary tokenization granularity, sequence length limits, or hyperparameters to optimize performance for particular deployment environments. The machine apparatus may include different types of devices such as assembly machines or transport systems. The terminal may be implemented as a desktop computer, a portable device, or an integrated control panel. In each case, the core configuration in which the server acquires logs, preprocesses them into time-series units, trains a generative AI model on these units, constructs prompt sentences including contextual metrics and emotion analysis, and generates context-aware outputs remains applicable and produces the technical advantages described above.

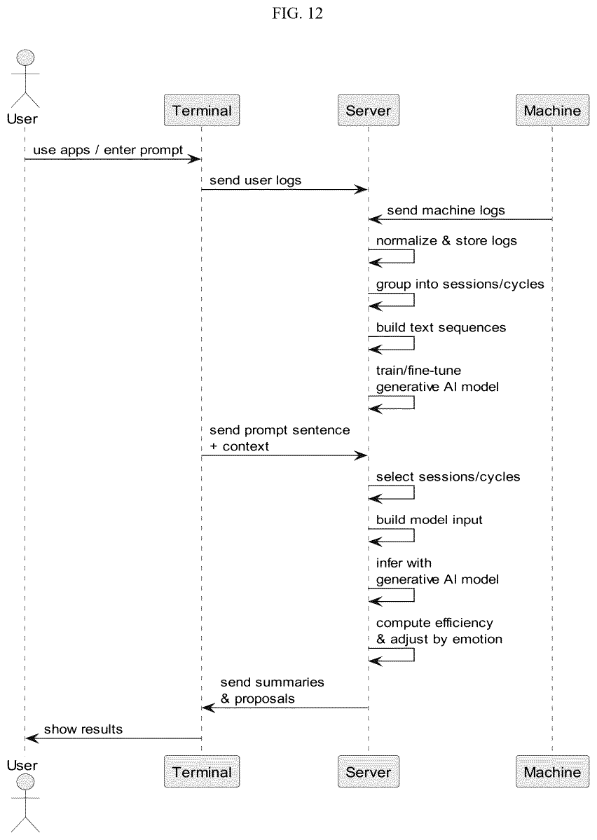

The following describes the processing flow using FIG. 12.
Step 1:

The terminal captures user operation events and display contents.

The terminal receives as input physical interactions by the user, including keyboard input, pointing-device movement and clicks, and window focus changes. The terminal calls operating system interfaces to obtain low-level event data, such as key codes, pointer coordinates, window identifiers, and active application identifiers. The terminal also acquires display information by reading text from active application windows or by performing optical character recognition on screenshots. The terminal attaches timestamps from a system clock and constructs structured event records containing at least event type, timestamp, application identifier, window title, and optional text content. As output, the terminal produces a time-stamped sequence of structured event records stored in a local buffer.
Step 2:

The terminal transmits buffered user events to the server.

The terminal uses the buffered sequence of event records generated in Step 1 as input. The terminal groups records into batches based on a time interval or a record-count threshold. The terminal serializes each batch into a structured message and transmits the message to the server over a network connection using a communication protocol. The terminal may perform simple data compression and retry logic in case of transmission failure. As output, the terminal delivers batched operation history information and display information to the server and clears the corresponding portion of the local buffer.
Step 3:

The server acquires work information from a machine apparatus.

The server receives as input state messages from at least one machine apparatus via an industrial communication interface. The server subscribes to variables representing operation states, positions, velocities, loads, and cycle identifiers. Upon reception of each message, the server reads the payload, attaches a server-side timestamp if necessary, and constructs a machine event record including at least a machine identifier, a cycle identifier, a timestamp, a state code, and numeric attributes. The server stores these machine event records into a time-series data store. As output, the server holds a continuous log of work information for each machine apparatus.
Step 4:

The server normalizes and stores all received events.

The server uses as input the user event batches received from the terminal and the machine event records obtained from the machine apparatus. The server converts timestamps to a unified time base, maps external identifiers (such as application names or device IDs) to internal canonical codes, and validates the presence and format of required fields. The server sorts events by timestamp and removes malformed or duplicate records. The server then inserts the normalized events into persistent storage structures such as event tables indexed by user, machine, and time. As output, the server maintains normalized, time-ordered event logs in a storage device for subsequent processing.
Step 5:

The server groups user events into sessions and machine events into work cycles.

The server takes as input a set of normalized events for a particular user or machine within a given time range. The server scans the events in chronological order and computes time differences between adjacent events. For user events, when the time difference exceeds a first threshold or when a primary application changes, the server defines a session boundary and starts a new session. For machine events, when the machine state transitions from idle or completed to active and back, the server defines a work-cycle boundary. The server aggregates events between boundaries into session objects and work-cycle objects, each annotated with start time, end time, and identifiers. As output, the server produces a collection of grouped session data and grouped work-cycle data.
Step 6:

The server removes noise and compresses event sequences within each group.

The server uses the session objects and work-cycle objects generated in Step 5 as input. For each group, the server filters out events classified as noise, such as instantaneous focus flickers or repeated identical states with duration below a second threshold. The server merges contiguous events with the same type and attributes by summing their durations and combining their contents. The server also aggregates low-level keyboard events into higher-level text segments and aggregates frequent, small pointer-movement events into larger movement blocks. By performing these data-processing operations, the server reduces redundancy while preserving essential temporal structure. As output, the server obtains denoised, compressed event sequences for each session and each work cycle.
Step 7:

The server converts grouped and compressed events into text sequences.

The server receives as input the denoised and compressed event sequences from Step 6. For each session, the server applies rule-based templates to translate structured records into narrative statements, inserting timestamps and application references into text. For each work cycle, the server generates descriptions of machine movements, waiting periods, and operations with quantitative values such as distances and times. The server concatenates these statements in chronological order to form a coherent text sequence that represents the entire session or work cycle. As output, the server produces one or more text sequences per session and per work cycle suitable for tokenization.
Step 8:

The server tokenizes text sequences and constructs training examples.

The server uses as input the text sequences created in Step 7. The server applies a tokenizer that segments text into units such as words or subwords and maps each unit to a token identifier. The server constructs token sequences for each text sequence and pads or truncates them to fit a predetermined maximum length. The server also constructs attention masks that mark valid token positions and, in some embodiments, prepares corresponding target sequences representing desired outputs such as summaries or explanatory text. As output, the server generates a set of training examples consisting of token sequences, attention masks, and optional target sequences stored in a training dataset.
Step 9:

The server trains or fine-tunes a generative AI model using the training dataset.

The server receives as input the token sequences, attention masks, and target sequences generated in Step 8. The server initializes a neural-network-based generative AI model with parameters representing embeddings, attention weights, and feedforward layers. The server repeatedly selects batches of training examples and, for each batch, computes a forward pass where the model converts input token sequences into output token probability distributions. The server then applies a loss function that compares predicted token distributions with target tokens, and computes gradients with respect to model parameters. The server updates the parameters using a gradient-based optimization algorithm. Through these data-processing and numerical-computation operations, the server incrementally reduces the loss. As output, the server obtains a trained or fine-tuned generative AI model whose parameters are stored in the storage device.
Step 10:

The user submits a prompt sentence for analysis or generation.

The user provides as input an instruction describing a desired operation, such as summarization of work or optimization of machine processes. The terminal presents an input field and the user types a prompt sentence, for example, “Please summarize my work for this morning based on my operation logs and display contents.” or “Analyze the following factory robot operation logs and propose methods to improve work efficiency. Focus on reducing unnecessary movement and waiting time.” The terminal combines the prompt sentence with user identification, a time range, or a machine identifier and transmits the request to the server. As output, the terminal sends a request message including the prompt sentence and related metadata to the server.
Step 11:

The server retrieves relevant sessions and work cycles corresponding to the request.

The server takes as input the request message received in Step 10, including the prompt sentence and metadata such as user identifier, time range, or machine identifier. The server queries its data store to select session objects and work-cycle objects that fall within the specified time range or relate to the specified machine. The server may rank or filter these groups based on activity level or relevance criteria. The server then collects the corresponding text sequences and, if necessary, truncates or merges them to satisfy length limits. As output, the server produces a context dataset composed of text sequences and associated time-series information for the requested analysis or generation.
Step 12:

The server performs emotion analysis based on user-related data.

The server uses as input recent user sessions, the prompt sentence, and optional additional signals such as error frequency or typing speed. The server extracts features such as average interval between keystrokes, number of corrections, and keywords indicating urgency or confusion. The server applies a classification model or heuristic rules to assign an emotion label, for example “high stress” or “neutral,” and computes a confidence score. The server stores this label and score as attributes associated with the current request. As output, the server generates emotion information that will be used as a conditioning factor in subsequent generation.
Step 13:

The server constructs a combined input sentence for the generative AI model.

The server receives as input the context dataset from Step 11, the prompt sentence from Step 10, the emotion information from Step 12, and, in machine-related cases, computed work-efficiency indices such as average cycle time or idle ratio. The server concatenates a system instruction, selected context text sequences, quantitative metrics expressed in natural language, the emotion indication, and the user's prompt sentence into a single combined input sentence. The server may insert guidance such as “provide a concise summary” or “provide detailed technical steps” based on the emotion label. As output, the server produces a structured combined input sentence that explicitly encodes temporal, quantitative, and emotional context.
Step 14:

The server performs inference with the generative AI model to generate textual outputs.

The server uses the combined input sentence constructed in Step 13 as input. The server tokenizes the sentence into a token sequence and feeds it into the generative AI model configured for inference. The server executes a forward computation to obtain probability distributions over possible next tokens and then applies a decoding algorithm to select tokens iteratively, forming an output sequence. During this process, the model's internal attention mechanisms relate different parts of the input, such as time-series descriptions, metrics, and instructions. The server continues generation until a termination condition is met. As output, the server obtains generated text representing summary information, document information, analysis information, and, when applicable, improvement proposals or optimization proposals.
Step 15:

The server computes and refines work-efficiency indices using generated analysis.

The server takes as input the generated analysis information from Step 14 and the underlying work information stored for the relevant machine cycles. The server parses the generated analysis to identify referenced metrics, and, if necessary, recalculates or refines these metrics using deterministic arithmetic operations on the raw work information. For example, the server may recompute cycle times or movement ratios for specific subsets of cycles mentioned in the generated analysis. The server then aligns the refined metrics with the generated text, updating or augmenting the output so that the narrative and numeric values are consistent. As output, the server produces a validated set of work-efficiency indices linked to the generated explanation.
Step 16:

The server adjusts the style and detail level of the generated text based on emotion information.

The server uses as input the generated text from Step 14 and the emotion label and confidence from Step 12. The server evaluates whether the length, complexity, and tone of the generated text meet the target style implied by the emotion label. If adjustment is needed, the server prepares a secondary prompt sentence instructing the generative AI model to rewrite the text, for example, “Rewrite the above explanation in a shorter and simpler form suitable for a user under time pressure” or “Expand the above explanation with more technical detail and step-by-step guidance.” The server feeds this secondary prompt together with the original generated text back into the generative AI model to obtain a revised version. As output, the server produces text whose expression content and detail level are adapted to the user's inferred emotional state.
Step 17:

The server returns the final outputs to the terminal.

The server receives as input the finalized summary information, document information, analysis information, and any improvement or optimization proposals from Steps 14 to 16. The server encapsulates these outputs in a response message containing structured fields for different sections of content and, if applicable, accompanying numeric tables of work-efficiency indices. The server transmits this response message to the terminal via the communication interface. As output, the server delivers a complete set of generated and processed information ready for presentation to the user.
Step 18:

The terminal displays the outputs and allows further user interaction.

The terminal uses as input the response message received from the server in Step 17. The terminal parses the message and renders the various sections on a display device, separating user-activity summaries, machine-process analyses, and optimization proposals into visually distinct panels or documents. The terminal may provide interface elements that allow the user to scroll, search, or select portions of the generated text. The user can then decide to accept the outputs or to refine them by entering additional prompt sentences, which become new inputs to the system. As output, the terminal presents the generated information to the user and optionally sends new refinement requests back to the server.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information processing systems that attempt to utilize user operation logs and display contents suffer from several technical limitations that impede effective prediction of user behavior and generation of useful system responses. First, typical logging mechanisms merely accumulate raw events in storage without robust, automated mechanisms for chronologically structuring those events, removing noise, or unifying them into clean, session-based time-series data. As a result, the underlying data exhibits high sparsity, redundancy, and inconsistency, which degrades the performance and stability of any downstream machine learning or rule-based processing.

Second, existing systems that apply machine learning to user logs generally rely on fixed-feature models or simple statistical techniques. These models are not configured to consume rich prompt sentences describing temporal context, are not designed to handle instruction-like inputs together with behavioral data, and therefore cannot fully exploit recent advances in generative AI models. Consequently, the systems are limited in their ability to learn nuanced behavior patterns and emotional states from sequential interactions and visual context, and they often fail to produce contextually appropriate and user-specific predictions. Third, in many cases, generated summaries or documents related to user work content are created in a static or template-based manner, independent of the user's emotional state and current interaction context. Such conventional generation pipelines do not integrate feedback about user acceptance or rejection of system suggestions as structured training signals. This leads to a feedback loop that is either absent or weak, preventing continuous improvement of prediction accuracy and recommendation quality at the system level.

Fourth, even when generative AI models are employed, they are typically used as isolated components, for example to generate text from a fixed prompt, without an integrated mechanism that (i) automatically converts structured time-series logs into prompt sentences, (ii) couples those prompts with explicit instruction information, and (iii) feeds post-hoc user feedback back into the model as labeled training data. Without such integrated orchestration, the system cannot systematically adapt its internal models to changing user habits or emotional tendencies, which results in stale or misaligned system behavior over time. Accordingly, there is a need for an improved computer-implemented system that: (1) automatically transforms raw user operation information and display information into cleaned, structured, session-based time-series data; (2) generates prompt sentences that combine behavioral descriptions and task instructions suitable for input to a generative AI model; (3) trains and refines a behavior prediction model that captures both user behavior patterns and emotional states; (4) uses that model in real time to predict next operations and to generate or adjust work-related summaries and documents; and (5) integrates user feedback signals as additional training data to iteratively improve the underlying generative AI model and associated behavior prediction model. Such a system improves the functioning of the computer itself by enhancing how the computer processes, structures, and exploits temporal interaction data, thereby enabling more accurate, adaptive, and efficient user assistance than was previously achievable.

The specific processing by the specific processing unit 290 of the data processing device 12 in Example 2 is realized by the following means.

The present invention provides a server comprising a processor and a memory storing instructions that, when executed by the processor, cause the server to acquire operation information and display information from an information processing apparatus used by a user and record the operation information and the display information in time series; organize the operation information and the display information recorded in time series based on time information, remove unnecessary information and erroneous information, and generate cleaned time-series data for learning; structure the cleaned time-series data as behavior sequences for each individual user and each individual usage session, convert the behavior sequences into textual sequences including description information and instruction information, and generate a prompt sentence for input to a generative artificial intelligence model; train or adjust the generative artificial intelligence model by using the prompt sentence and the behavior sequences as learning data, and generate a behavior prediction model representing a behavior pattern and an emotional state of the user; generate, based on the behavior prediction model and a prompt sentence generated in accordance with a current operation situation of the user, prediction information including a next operation of the user or a plurality of candidate operations of the user; generate a summary of a work content of the user or automatically generate a work-related document based on the prediction information, and adjust content of the summary or the work-related document in consideration of the emotional state of the user estimated by the behavior prediction model; and acquire feedback information including acceptance information or rejection information from the user with respect to the prediction information, and perform relearning of the behavior prediction model by using the feedback information as additional learning data for the generative artificial intelligence model and update a behavior prediction accuracy and a content of the prediction information. This enables improvement of the operation of the computer-based system itself by providing an integrated technical mechanism that (i) transforms raw, noisy interaction data into structured prompts consumable by a generative AI model, (ii) learns and refines user-specific behavior and emotion patterns, and (iii) closes the loop with explicit user feedback, thereby achieving more accurate, adaptive, and context-aware predictions and automatically generated work outputs.

The term “operation information” refers to data representing user-initiated interactions with an information processing apparatus, including, for example, input events, command executions, selections, and other observable actions performed by the user through an input interface.

The term “display information” refers to data representing visual or graphical contents presented on an output interface of an information processing apparatus, including, for example, screen states, window titles, document identifiers, resource locators, and other attributes of displayed elements.

The term “time series” refers to an ordered sequence of data elements each associated with temporal information, such that the sequence reflects the chronological order in which corresponding events or states occurred.

The term “cleaned time-series data” refers to time-series data that has been processed to remove redundant, inconsistent, irrelevant, or erroneous entries, and that has been normalized or otherwise adjusted to improve its suitability for subsequent analysis or learning.

The term “behavior sequence” refers to an ordered collection of elements representing user operations and corresponding contextual information within a defined time period or session, arranged according to their temporal order.

The term “usage session” refers to a bounded interval of user interaction with an information processing apparatus, identified by temporal continuity, context, or explicit session demarcation, within which a behavior sequence is defined.

The term “description information” refers to textual or symbolic content that expresses, in natural language or a structured representation, the circumstances, context, or meaning of one or more user operations or display states.

The term “instruction information” refers to textual or symbolic content that specifies a task, query, constraint, or desired output for a processing component, including, for example, directives given to a generative AI model.

The term “prompt sentence” refers to a text or text-like sequence, including description information and instruction information, that is formatted for input to a generative AI model in order to elicit a predicted output, continuation, or response.

The term “generative artificial intelligence model” refers to a machine-learned model configured to produce new data, such as text or structured information, in response to input data, including but not limited to models based on probabilistic or neural network architectures.

The term “behavior prediction model” refers to a model derived from or associated with a generative artificial intelligence model, which is configured to infer or generate predictions of future user operations or behavior patterns based on past interaction data and current context.

The term “behavior pattern” refers to a recurrent or characteristic sequence or structure of user operations observed over time, which can be statistically or algorithmically inferred from historical interaction data.

The term “emotional state” refers to an inferred representation of a user's affective condition, such as positive, negative, or neutral sentiment, determined from interaction patterns, content, or other observable signals.

The term “prediction information” refers to data indicating one or more anticipated future user operations or states, including, for example, predicted action types, targets, timings, or associated confidence measures.

The term “work content” refers to tasks, activities, or subject matter associated with a user's use of an information processing apparatus, including, for example, documents, communications, operations, and related metadata.

The term “work-related document” refers to a data structure or file generated or processed in connection with a user's work content, including, for example, reports, summaries, forms, templates, or other digital documents.

The term “summary” refers to a condensed representation of work content or interaction content that selectively includes salient information while omitting less relevant details.

The term “feedback information” refers to data acquired from a user, explicitly or implicitly, that indicates acceptance, rejection, modification, or evaluation of a prediction, suggestion, or generated output.

The term “acceptance information” refers to feedback information that indicates the user's approval, adoption, or execution of a prediction or suggestion provided by the system.

The term “rejection information” refers to feedback information that indicates the user's disapproval, dismissal, or non-use of a prediction or suggestion provided by the system.

The term “relearning” refers to a process in which a model that has previously been trained is further trained or fine-tuned using additional data, including feedback information, to update its parameters and improve its performance.

The term “behavior prediction accuracy” refers to a quantitative or qualitative measure of how closely predicted user operations or behavior patterns generated by the behavior prediction model match actual user operations or observed patterns.

The term “current operation situation” refers to a state of ongoing interaction between the user and the information processing apparatus, including recent operation information, display information, and related contextual data available at a given time.

In one embodiment, a server cooperates with at least one terminal operated by a user to implement the claimed system. The server comprises at least one processor, a memory, a network interface, and a non-transitory storage device. The terminal comprises at least one processor, an input interface such as a keyboard, a pointing device, or a touch panel, and a display device. The server and the terminal communicate via a wired or wireless communication network, such as a local area network or a wide area network.

The terminal executes a client program implemented, for example, in a high-level programming language and integrated with an operating system event API. The terminal captures operation information by intercepting low-level user interface events, such as key press events, pointer click events, window focus events, and application launch events, using an event listener mechanism of the operating system. The terminal captures display information by querying the operating system for the active window handle, application identifier, uniform resource locator, document identifier, and visible title text, and by reading the layout of user interface components drawn on the display device.

The terminal packages the operation information and the display information into a structured data record including, at a minimum, a user identifier, a session identifier, a timestamp, an operation type, an operation parameter, an application identifier, a display state identifier, and a content summary field. The terminal transmits the structured data record to the server through the network interface using a message protocol such as Hypertext Transfer Protocol over Transport Layer Security.

The server stores the received structured data records in a data store implemented as a relational database system or a key-value store. The server organizes the records into a time-series data structure indexed by user identifier and timestamp. The server converts timestamp strings into an internal time representation and sorts the records in ascending temporal order. The server identifies noise by detecting records that violate predefined consistency rules, for example records having missing user identifiers, timestamps that are out of an allowed chronological range, or operation types that contradict the current application state. The server removes or corrects such records and thereby generates cleaned time-series data for each user and for each usage session.

The server generates behavior sequences by grouping the cleaned time-series data into contiguous segments corresponding to usage sessions. For each segment, the server constructs a sequence object in which each element comprises fields such as time-of-day, elapsed time since a previous operation, operation type, operation target, application identifier, display context, and derived contextual features including day-of-week, work-type classification, and user workload indicator. The server represents categorical fields as integer indexes and numeric fields as normalized floating point values. The server stores the behavior sequences in a sequence table within the storage device.

The server converts the behavior sequences into textual sequences. The server constructs description information by using a rule-based template generator that maps each operation element into a natural language fragment. For example, when an element indicates an operation type corresponding to opening a document in a document editor application at 9:05, the server generates a fragment such as “At 09:05 the user opened a document in a document editor.” The server concatenates a plurality of such fragments in chronological order to form a textual description of a behavior sequence.

The server generates instruction information to express a desired prediction or generation task. The server determines, based on a target objective, whether the instruction information should request a prediction of a next operation, a generation of a work-related document, or a summary of work content. The server appends the instruction information to the description information to form a prompt sentence suitable for input to a generative AI model.

In one concrete example, the server generates a prompt sentence such as:
“At 08:55 the user opened a web browser. At 08:59 the user accessed the company portal. On the previous weekdays at 09:00 the user accessed the internal dashboard site. Based on this history, predict the single most likely website that the user will access at 09:00 today. Answer with the website address only.”

In another example, the server generates a prompt sentence such as:
“User activity history: At 09:01 the user opened a word processor. At 09:02 the user created a document titled ‘January Monthly Sales Report’. At the beginning of each month the user performs similar actions. Predict the most appropriate document template name that should be suggested next. Answer with the template name only.”

The server employs a generative AI model implemented as a neural network of the transformer type. The server stores in memory a parameterized model comprising a plurality of layers including an embedding layer, a plurality of self-attention layers, feed-forward layers, and an output projection layer. The server tokenizes each prompt sentence using a tokenizer algorithm that maps fragments of text to token identifiers. The server feeds the token identifiers as an input sequence into the generative AI model. The generative AI model processes the input sequence through multiple self-attention layers, each layer computing attention weights that represent dependencies among token positions and combining token embeddings using learned weight matrices.

During a training phase, the server supplies, as target data, a token sequence corresponding to a ground-truth next operation, a ground-truth summary, or a ground-truth work-related document. The server computes a loss value, for example a cross-entropy loss, between the output probability distribution produced by the generative AI model and the target token sequence. The server updates the parameters of the generative AI model using a gradient descent algorithm, for example an adaptive gradient optimizer, to minimize the loss over a plurality of training iterations. The server thus creates a behavior prediction model that captures statistical relationships between time-series user behavior patterns, contextual display information, and desired outputs such as predicted operations and summarized work content.

The server performs feature engineering at the data preprocessing level to improve prediction accuracy and processing efficiency. The server generates additional features such as cumulative counts of actions per time-of-day segment, frequency-based encodings of visited resources, and rolling-window statistics of user response times to recommendations. The server incorporates such features as additional tokens or as auxiliary numeric inputs that are concatenated to token embeddings at specific positions. By doing so, the server enables the generative AI model to exploit fine-grained temporal and behavioral patterns that are not readily apparent from raw logs alone.

The server employs a specific training schedule that uses mini-batches of behavior sequences grouped by similar lengths to minimize padding overhead and improve computation efficiency on a graphics processing unit. The server maintains a training buffer that caches recently collected feedback information and integrates such information in an online or periodic retraining process. By updating the behavior prediction model with recent feedback, the server reduces prediction error for evolving user habits and improves convergence speed relative to a static training regime.

The server derives an emotional state of the user by computing sentiment features from text content in display information and from textual feedback provided by the user. The server feeds such sentiment features, for example polarity scores and emotional category indicators, as additional input channels to the generative AI model or as input to a separate classification network whose output is then combined with the behavior prediction model output. The server thereby generates an emotional state representation that is used as a conditioning signal when generating summaries and work-related documents. For example, when the emotional state representation indicates that the user is under high stress, the server adjusts the writing style of a generated summary to be more concise and directive, reducing cognitive load.

The server, during an inference phase, receives from the terminal a representation of a current operation situation containing a portion of the most recent behavior sequence. The server formats this representation into a prompt sentence similar to those used during training, including description information of recent operations and instruction information specifying a prediction task. The server processes the prompt sentence through the trained generative AI model to obtain an output token sequence representing a predicted operation, a proposed summary, or a proposed document content.

The terminal receives prediction information from the server, labeled with a suggestion identifier and associated parameters such as a predicted action type, a target resource, and an estimated execution time. The terminal displays the prediction information as a suggestion on the display device, for example in the form of a dialog or notification banner. When the user accepts the suggestion, the terminal performs an operation that controls an application or the operating system, such as opening an application, loading a specific document, or navigating to a resource. By performing such operations automatically in response to prediction information, the system goes beyond mere data analysis and effects concrete control over hardware and software components.

The terminal transmits feedback information indicating whether the user accepted or rejected the suggestion. The server stores the feedback information linked to the behavior sequence and the corresponding prompt sentence. The server constructs additional training pairs in which each input consists of the original prompt sentence and each target consists of the actually executed operation or the accepted content. The server uses these training pairs in a further training cycle, thereby refining the behavior prediction model so that future prediction information better aligns with the user's actual behavior and preferences.

In a practical scenario, the user repeatedly opens a particular internal dashboard site at a specific time of day. The server, by aggregating and cleaning time-series data, identifies this pattern and encodes it into the behavior prediction model. When the same time-of-day and similar preceding context occur, the server predicts access to the internal dashboard and transmits a suggestion to the terminal to open the site automatically. Because the server converts raw logs into structured sequences and uses a transformer-based generative AI model with learned temporal dependencies, the server can infer the pattern with a higher precision and in a shorter computation time than rule-based schedulers or simple statistical models.

From a computer-technology perspective, the described system improves the operation of the underlying computing infrastructure. The server reduces storage overhead and input/output latency by removing redundant and erroneous records during the cleaning phase, thereby decreasing the volume of data that must be loaded and processed for model training. The server improves cache utilization and processing throughput on processors and accelerators by sorting behavior sequences by length and by batching sequences with similar structures. The server improves prediction accuracy by integrating multi-modal features, including operation information and display information, into a unified representation fed into a deep neural network with self-attention mechanisms, which can capture long-range dependencies more efficiently than traditional recurrent networks.

The system also introduces a non-conventional processing pipeline that differs from a mere automation of human analysis. A human operator would not typically convert large-scale logged events into carefully structured prompt sentences that include both behavior descriptions and machine-readable instruction information, nor would a human operator iteratively adjust hundreds of millions of model parameters in response to fine-grained feedback information. The server, by applying algorithmic operations such as gradient-based optimization, feature encoding, and self-attention, performs pattern extraction and representation learning that are not feasible by manual inspection. This technical arrangement yields quantifiable improvements in error rates of predicted operations, latency of generating suggestions, and utilization of computational resources.

In another embodiment, the server uses a variant of a transformer network in which positional encodings are replaced by learned relative position embeddings. The server encodes the difference in time between successive operations as a feature that is added to token embeddings. This configuration enables the model to generalize across different absolute times while still learning patterns related to temporal intervals. The server can also apply regularization techniques such as dropout and weight decay to prevent overfitting on specific users'behavior, thereby providing a more robust behavior prediction model for deployment across multiple users and terminals.

In yet another embodiment, the server uses a modular architecture in which a dedicated preprocessing module handles data cleaning and sequence construction, a prompt generation module handles conversion into textual sequences and addition of instruction information, a model training module manages batch selection and weight updates, and an inference module handles real-time prediction requests from terminals. Each module communicates via defined data structures stored in the memory, which enhances maintainability and scalability. The modularization also allows deployment across multiple server machines, where a load balancer distributes inference requests and a separate training cluster performs offline model updates.

By implementing the above-described components and processing flows, the server, the terminal, and the user jointly realize a system that transforms raw interaction logs into structured inputs for a generative AI model, learns detailed behavior patterns and emotional states, and provides accurate and adaptive prediction information that directly controls or assists software and hardware in the real world, thereby improving the underlying computer technology rather than merely automating a mental process.

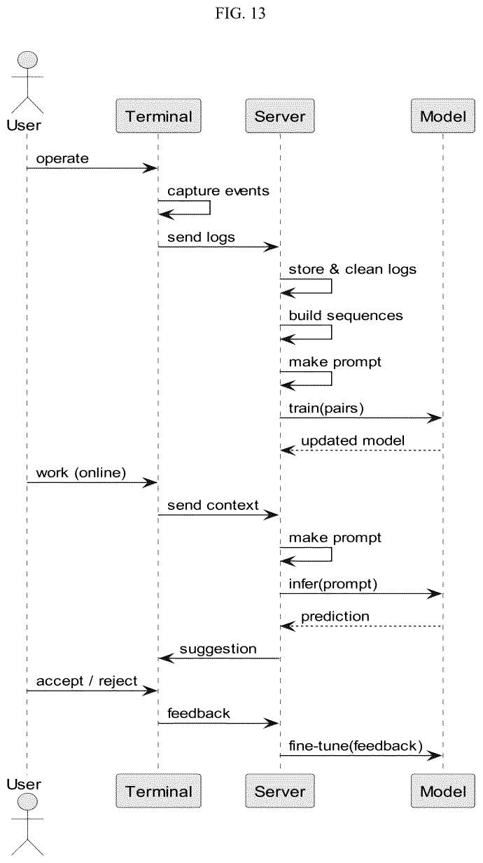

The following describes the processing flow using FIG. 13.
Step 1:

Terminal captures raw user interactions and screen context.

Terminal monitors low-level input events provided by an operating system API, such as key presses, mouse clicks, pointer moves, touch gestures, window focus changes, and application launches.

Input: hardware-generated input events and current screen state from the operating system.

Terminal converts each event into an operation information record including fields such as a user identifier, a session identifier, a timestamp, an operation type, and operation parameters (for example, key code, mouse coordinates, or control identifier). Terminal simultaneously queries the operating system for display information such as the active application identifier, the active window title, a resource locator, and visible document metadata.

Output: a combined raw event record that includes operation information and display information for each observed user interaction.
Step 2:

Terminal packages raw records and transmits them to the server.

Terminal buffers multiple raw event records in memory and aggregates them into a message payload. Terminal serializes the payload into a structured format, for example a delimited text or a structured object, and compresses it if necessary.

Input: buffered raw event records produced in Step 1.

Terminal sends the payload to the server through a network interface using a secure communication protocol. The network stack segments the payload into packets and transmits the packets over a wired or wireless communication link.

Output: a network message containing a batch of raw operation information and display information delivered to the server.
Step 3:

Server receives, validates, and stores raw records.

Server listens on a network port for incoming messages from terminals. Upon receipt, server parses the message payload, verifies structural integrity, checks authentication tokens, and discards messages that fail validation.

Input: network message containing raw operation information and display information from one or more terminals.

Server converts each parsed record into a row of a database table or an entry in a time-series storage. Server writes the records to persistent storage, attaching a server-side reception timestamp if needed.

Output: a stored raw log dataset composed of time-stamped rows that preserve operation information and display information for each user and session.
Step 4:

Server constructs time-ordered user sessions and cleans noise.

Server queries the storage to retrieve raw log rows for a particular user or a particular time interval. Server sorts these rows by timestamp in ascending order. Server groups rows into usage sessions based on session identifiers or inactivity thresholds.

Input: stored raw log dataset retrieved from persistent storage.

Server executes data processing operations to detect and remove noise, such as rows with missing user identifiers, timestamps outside a valid range, contradictory application identifiers, or unrealistically dense event sequences likely generated by background processes. Server may merge multiple closely spaced identical events into a single representative event.

Output: a set of cleaned, time-ordered log sequences, each sequence corresponding to a user session.
Step 5:

Server transforms cleaned logs into structured behavior sequences.

Server iterates over each cleaned log sequence and constructs a behavior sequence object. For each log entry, server calculates derived features, such as elapsed time since the previous event, time of day normalized to a numeric range, day of week, and counts of prior occurrences of the same operation type in the current session.

Input: cleaned, time-ordered log sequences from Step 4.

Server encodes categorical fields, such as operation type or application identifier, as integer indices, and normalizes numeric fields, such as elapsed time, into a predefined range. Server appends these feature vectors to a behavior sequence for the corresponding session.

Output: a collection of behavior sequences, each behavior sequence being a list of feature-enriched elements representing user operations over time.
Step 6:

Server generates textual descriptions of behavior sequences.

Server converts each element of a behavior sequence into a natural language fragment. Server references templates that map an operation type, its target, and its contextual features to a text string, such as “At 09:05 the user opened a document in a word processor.”

Input: feature-enriched behavior sequences from Step 5.

Server concatenates the generated fragments in chronological order to obtain a coherent description text for each sequence. The concatenation process preserves time order and may insert separators or paragraph breaks to mark boundaries between sessions.

Output: a set of description texts, each describing a user's behavior during a session.
Step 7:

Server generates instruction information and constructs prompt sentences.

Server determines a prediction or generation objective for each training or inference case, such as predicting a next operation, summarizing work content, or generating a suggested document. Based on this objective, server composes instruction information as a natural language directive, for example “Based on this history, predict the single most likely website that the user will access at 09:00 today. Answer with the website address only.”

Input: description texts from Step 6 and task metadata specifying the desired prediction or generation objective.

Server appends the instruction information to the description text, often separated by a special marker or a new line, to form a complete prompt sentence to be supplied to a generative AI model.

Output: a set of prompt sentences, each containing both description information and instruction information.
Step 8:

Server assembles training pairs for the generative AI model.

Server retrieves from storage the ground-truth outcome associated with each prompt sentence, such as the actual next operation executed by the user or the actual document content that was later created.

Input: prompt sentences from Step 7 and ground-truth behavior data or document data recorded in the log.

Server formats the ground-truth outcome as a target text sequence, for example “https://example-dashboard.internal” for a predicted website, or “Monthly Sales Report template” for a predicted document template. Server pairs each prompt sentence with its corresponding target text to form a training example.

Output: a set of training pairs, each pair consisting of a prompt sentence and a target text.
Step 9:

Server tokenizes training data and feeds it into the generative AI model.

Server invokes a tokenizer component that converts text strings into sequences of token identifiers suitable for the generative AI model. The tokenizer applies a predetermined vocabulary and subword segmentation rules.

Input: training pairs comprising prompt sentences and target texts from Step 8.

Server concatenates each prompt sentence and its target text with appropriate delimiters and produces input token sequences and label token sequences. Server loads batches of these sequences into memory and passes them through the input layer of a transformer-based generative AI model.

Output: tokenized batches ready for training and corresponding model inputs for forward and backward passes.
Step 10:

Server trains and updates the behavior prediction model.

Server performs a forward pass in which the generative AI model processes each input token sequence through multiple transformer layers that compute attention scores and generate hidden representations. Server computes a probability distribution over the vocabulary at each output position.

Input: tokenized training batches and current model parameters.

Server compares the predicted token distributions to the label token sequences and computes a loss value, such as cross-entropy. Server then performs a backward pass to calculate gradients of the loss with respect to model parameters. Server updates the parameters using an optimization algorithm, adjusting weights to reduce the loss. Through repeated iterations, server shapes the generative AI model so that it predicts the correct next tokens based on the prompt sentences.

Output: an updated behavior prediction model trained to map prompt sentences to accurate predictions of operations, summaries, and work-related content.
Step 11:

Terminal provides a current operation situation for online prediction.

Terminal monitors recent user operations and screen contents in real time, using the same mechanisms as in Step 1, but with reduced buffering to support low-latency operation. Input: live operation events and current display information from the operating system. Terminal composes a short sequence representing the most recent segment of the user's activity and transmits this sequence to the server as a prediction request.

Output: a current context message describing the user's ongoing behavior and display state.
Step 12:

Server generates a prompt sentence from the current context for inference.

Server receives the current context message and integrates it with stored historical information for the same user if needed. Server creates a description text summarizing the recent operations and display states, similar to the method used in Step 6.

Input: current context message from Step 11 and optional historical behavior data. Server selects an appropriate instruction, such as “Based on the following recent activity, predict the single most likely next user operation. Answer with one operation type and one target.” and appends it to the description text to create an inference prompt sentence. Output: an inference prompt sentence ready to be input to the trained generative AI model.
Step 13:

Server executes inference using the trained generative AI model.

Server tokenizes the inference prompt sentence using the same tokenizer that was used during training. Server supplies the token sequence to the input of the trained generative AI model and performs a forward pass without updating parameters.

Input: inference prompt sentence from Step 12 and the trained behavior prediction model parameters.

Server obtains an output token sequence that represents a predicted next operation or a generated summary or document content. Server may apply decoding strategies such as greedy selection or sampling to choose a final output text.

Output: a prediction text conveying the predicted action or generated content in natural language or structured text form.
Step 14:

Server converts prediction text into structured prediction information.

Server parses the prediction text to extract fields such as a predicted action type, a target resource identifier, and an optional timing parameter. If the prediction text follows a predefined format, server splits the text at delimiters or applies pattern matching rules to map segments to specific fields.

Input: prediction text generated by the generative AI model in Step 13.

Server constructs a structured prediction object that encodes the predicted operation and its parameters in a machine-readable representation that the terminal can use for control.

Output: structured prediction information including one or more candidate operations and associated metadata.
Step 15:

Terminal presents suggestions and executes accepted predictions.

Terminal receives the structured prediction information from the server and interprets the fields to generate a user-facing suggestion. Terminal displays the suggestion on the display device using a graphical user interface element.

Input: structured prediction information from Step 14.

When the user accepts the suggestion, terminal issues commands to the operating system or to an application to perform the predicted operation, such as opening a specified document or navigating to a specified resource. Terminal records the execution as a new operation event to be logged.

Output: user-visible suggestions, executed operations in the computing environment, and corresponding new operation records.
Step 16:

User provides feedback, and terminal sends feedback to the server.

User indicates acceptance or rejection of the suggestion by interacting with controls on the suggestion interface, such as “Accept” or “Dismiss” buttons, or by ignoring the suggestion until it expires.

Input: user actions in response to displayed suggestion.

Terminal encodes the result as feedback information including a suggestion identifier, an acceptance or rejection flag, a timestamp, and optional user comments. Terminal transmits this feedback information to the server using the communication channel.

Output: structured feedback information reflecting the user's evaluation of the prediction.
Step 17:

Server incorporates feedback into further training.

Server stores the feedback information in association with the original behavior sequence, the prompt sentence, and the prediction text. Server uses this association to build new training pairs in which accepted predictions are treated as positive examples and rejected predictions may be used as negative examples or replaced with the actual operation that occurred.

Input: feedback information from Step 16 and corresponding original training or inference context from storage.

Server adds these new training pairs to the training dataset and periodically retrains or fine-tunes the generative AI model following the same procedure as in Step 10. This data processing step refines model parameters so that future predictions become more aligned with observed user behavior and preferences.

Output: an updated behavior prediction model that reflects user feedback and exhibits improved accuracy and robustness.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional systems that generate summaries or documents from user activity logs generally treat the collected logs as undifferentiated text and apply a generative artificial intelligence model in a single step. Such systems suffer from multiple technical shortcomings.

First, these systems typically ingest raw operation logs and display contents without rigorous time-series preprocessing or noise reduction. As a result, redundant or rapidly repeated operations, which are common in real user interfaces, significantly increase data volume and introduce noise. This leads to inefficient use of processing resources, increased latency in downstream processing, and degraded quality of the generated summaries or documents. Second, conventional architectures do not construct explicit behavioral feature data or behavior learning models that capture user-specific patterns over time. Without a dedicated behavior learning model, the generative artificial intelligence model receives only shallow or unstructured context. This limits the model's ability to utilize regularities in user behavior and prevents accurate, personalized generation of summaries or documents.

Third, known systems frequently ignore the user's emotional state, or at most apply simple sentiment analysis to the final text output. They do not integrate a time-resolved emotion index, derived from the underlying operation information and display information, into the core generation pipeline. As a consequence, the generated outputs do not adapt their expression style, level of emphasis, or content selection to the user's emotional state, resulting in reduced usability and a one-size-fits-all user experience.

Fourth, many existing solutions treat user queries as standalone prompts and do not algorithmically link the query to a well-specified time range and processing domain over the stored logs. They fail to construct structured prompt sentences that systematically combine (i) preprocessed behavioral context, (ii) learned behavioral patterns, and (iii) emotion indices. This reduces the relevance, coherence, and reproducibility of generative outputs in response to user queries.

Fifth, typical systems do not close the loop between user feedback and the underlying models. They lack mechanisms to associate user evaluations and corrections with the specific operation information, display information, prompt sentences, and emotion indices used for generation. Therefore, the system cannot automatically refine behavior learning models or prompt generation logic based on actual usage, causing long-term stagnation in quality. Accordingly, there is a need for a computer-implemented system that: (1) performs structured, time-series preprocessing and noise removal on operation information and display information; (2) generates behavioral feature data and maintains an explicit behavior learning model; (3) estimates a time-resolved emotion index from textual and meta-information; (4) constructs context-rich prompt sentences that integrate behavioral patterns and emotion indices in response to user inquiries; (5) uses a generative artificial intelligence model under such structured prompts to generate natural-language summaries and documents; (6) algorithmically adjusts generated content based on the emotion index and policy rules; and (7) utilizes explicit user feedback to update the behavior learning model and prompt generation parameters. Such a system would improve the technical functioning of computer-based summarization and document generation engines by reducing noise, improving relevance and personalization, and enabling adaptive, feedback-driven refinement of the generation process.

The specific processing by the specific processing unit 290 of the data processing device 12 in Application Example 2 is realized by the following means.

The present invention provides a server comprising a processor and a memory storing instructions which, when executed by the processor, cause the processor to acquire operation information and display information from an information processing apparatus operated by a user; preprocess the operation information and the display information by arranging them in chronological order based on time-series information and removing unnecessary information including identical operations repeated within a short time period to reduce noise and data volume; generate behavioral feature data from the preprocessed operation information and the preprocessed display information, execute a machine learning algorithm using the behavioral feature data as input, and construct or update a behavior learning model that learns a behavioral pattern of the user; execute an emotion analysis algorithm based on character information and meta-information extracted from the operation information and the display information, estimate an emotional state of the user for each time interval, and record the emotional state as an emotion index; analyze inquiry information received from the user, specify a time range and a target processing domain corresponding to the inquiry information, and acquire preprocessed operation information, preprocessed display information, the behavioral pattern, and the emotion index corresponding to the time range; generate a prompt sentence for summarizing behavioral content or work content in a target period based on the acquired operation information, display information, behavioral pattern, and emotion index, and generate input data in which the prompt sentence and the acquired information are incorporated; input the input data into a generative artificial intelligence model and cause the generative artificial intelligence model to generate, in a natural language, a summary of work content of the user or a document as a generated summary; automatically adjust an expression style, a writing style, and emphasized content of the generated summary based on the emotion index and a policy rule to generate output information corresponding to the emotional state of the user; convert the output information into a predetermined display format, transmit the output information to the information processing apparatus of the user, and cause the output information to be presented to the user; and acquire evaluation information or correction information from the user with respect to the presented summary or document, associate the evaluation information or the correction information with the operation information, the display information, the prompt sentence, and the emotion index used for generation, record the associated information, and update at least one of a parameter of the behavior learning model and a parameter of prompt generation processing based on the associated information. This enables improved computer functionality for automated summarization and document generation by systematically reducing noise in input logs, providing the generative artificial intelligence model with structured behavior-and emotion-aware context via prompt sentences, dynamically adapting generated content to the user's emotional state and policy constraints, and continuously refining internal models and prompt generation logic based on explicit user feedback, thereby increasing relevance, personalization, and efficiency of the overall system.

The term “system” refers to an arrangement of one or more computing devices, storage devices, and communication interfaces that cooperate to execute the processing described herein.

The term “processor” refers to a hardware computation unit, such as a central processing unit or an execution core, capable of executing instructions to perform logical, arithmetic, control, and input/output operations.

The term “memory” refers to a hardware storage medium, such as a semiconductor memory or magnetic storage, that stores instructions and data for access by the processor.

The term “information processing apparatus” refers to an electronic device operated by a user, such as a general-purpose computer, a portable terminal, or a specialized terminal, that generates operation information and display information.

The term “user” refers to a human operator or an organization represented by one or more human operators who interact with the information processing apparatus and utilize the system.

The term “operation information” refers to data indicating operations performed on an information processing apparatus, including input events, application activations, resource accesses, and other interaction records.

The term “display information” refers to data indicating content presented on a display unit of an information processing apparatus, including textual content, graphical content, identifiers of displayed resources, and associated metadata.

The term “time-series information” refers to temporal data associated with operation information or display information, such as timestamps or time indices, that enable chronological ordering of events.

The term “preprocess” refers to processing that converts raw operation information and display information into a normalized, filtered, and structured form suitable for subsequent analysis.

The term “unnecessary information” refers to portions of operation information or display information that do not materially contribute to characterization of user behavior or content, such as redundant or rapidly repeated identical operations, and that may be removed to reduce noise.

The term “behavioral feature data” refers to numerical or symbolic representations derived from preprocessed operation information and display information, which capture characteristics of user behavior for use as input to a machine learning algorithm.

The term “machine learning algorithm” refers to a computational procedure that adjusts internal parameters of a model based on training data so as to approximate a mapping between inputs and outputs or to discover patterns in the data.

The term “behavior learning model” refers to a model, produced or updated by a machine learning algorithm, that represents behavioral patterns of a user and can be used to infer, characterize, or predict user behavior.

The term “behavioral pattern” refers to a recurrent or statistically significant sequence or configuration of user actions, resource usages, or content interactions over time.

The term “character information” refers to textual data, including characters, words, and sentences, extracted from operation information, display information, or user inputs.

The term “meta-information” refers to descriptive data associated with operation information or display information, such as identifiers, categories, timestamps, or contextual attributes that characterize the underlying data.

The term “emotion analysis algorithm” refers to a computational procedure that estimates an emotional state from character information and meta-information by classification, regression, or other inference techniques.

The term “emotional state” refers to a psychological condition of the user, such as satisfaction, stress, joy, or frustration, as inferred from operation information, display information, or other signals.

The term “emotion index” refers to a data structure that records, for each time interval, one or more values indicating an estimated emotional state of the user and, optionally, its intensity or confidence.

The term “inquiry information” refers to natural-language or structured data received from the user that expresses a request for a summary, a document, or other system-generated output.

The term “time range” refers to a continuous or discrete interval on a time axis associated with operation information and display information, selected for analysis or summarization.

The term “target processing domain” refers to a category or scope of processing, such as a work type, application category, device type, or functional area, to which generation of a summary or document is directed.

The term “prompt sentence” refers to a natural-language instruction or query formulated for input to a generative artificial intelligence model, specifying a desired output and providing contextual information.

The term “prompt generation processing” refers to processing that selects, structures, and combines contextual data and instructions to produce a prompt sentence and associated input data for a generative artificial intelligence model.

The term “generative artificial intelligence model” refers to a trained model that generates new data, including natural-language text, in response to input data and a prompt sentence, based on learned patterns from training data.

The term “input data” refers to a data structure provided to a generative artificial intelligence model, including a prompt sentence and associated contextual information derived from operation information, display information, behavioral patterns, and emotion indices.

The term “summary” refers to a condensed natural-language representation of behavioral content or work content, generated by a generative artificial intelligence model based on input data.

The term “document” refers to a structured natural-language output, such as a report, explanation, or description, generated by a generative artificial intelligence model based on input data.

The term “generated summary” refers to a summary or document produced by a generative artificial intelligence model in response to a prompt sentence and associated input data.

The term “policy rule” refers to a predetermined condition, constraint, or guideline that governs generation, selection, or modification of output information, such as style constraints, disclosure limitations, or domain-specific requirements.

The term “expression style” refers to characteristics of wording in text, such as level of formality, politeness, or directness.

The term “writing style” refers to structural and stylistic attributes of text, such as length, level of detail, tone, or narrative structure.

The term “emphasized content” refers to portions of output information that are highlighted, prioritized, or elaborated relative to other content, based on behavioral patterns, emotion indices, or policy rules.

The term “output information” refers to processed natural-language text and associated formatting or metadata that are ready to be delivered to an information processing apparatus for presentation to the user.

The term “predetermined display format” refers to a specified layout or representation for output information, such as a markup structure, document format, or graphical arrangement suitable for display by an information processing apparatus.

The term “presentation control processing” refers to processing that converts output information into a display format, transmits it to an information processing apparatus, and causes the information to be visually or audibly presented to the user.

The term “evaluation information” refers to data indicating a user's assessment of a generated summary or document, such as rating values, selection signals, or qualitative feedback.

The term “correction information” refers to data indicating modifications made by the user to a generated summary or document, such as edited text, inserted content, or deletions.

The term “associated information” refers to a collection of related data items, including operation information, display information, a prompt sentence, an emotion index, and evaluation information or correction information, that are stored together with explicit relationships.

The term “parameter” refers to a numerical or symbolic value that determines behavior of a model or processing logic, and that can be adjusted during training, learning, or configuration.

The term “parameter of the behavior learning model” refers to an internal value of the behavior learning model, such as a weight, bias, or threshold, that influences the model's output and is updated based on training or feedback.

The term “parameter of the prompt generation processing” refers to a configuration value or rule used in generating a prompt sentence and input data, such as selection thresholds, template elements, or weighting factors for including context.

The term “subsequent summaries or documents” refers to summaries or documents generated by the system after a given generation event, which may be influenced by updated parameters or models derived from prior evaluations and corrections.

In one embodiment, a system includes a server, one or more terminals, and a communication network connecting the server and the terminals. The server includes at least one processor and at least one memory storing instructions which, when executed by the processor, cause the processor to perform the processing described below. The terminal includes at least one processor and at least one memory configured to acquire user activity and to present generated information to a user.

Server runs on a general-purpose computing platform such as a rack-mounted or virtualized computer system having a central processing unit (CPU), a main memory, a non-volatile storage device, and a network interface. Server uses a general-purpose operating system and hosts a software stack that may include a web server framework, an application framework, and a database management system. In one example, server uses a structured database to store operation information, display information, behavioral feature data, emotion indices, and feedback data.

Terminal operates as an information processing apparatus used by a user. Terminal can be implemented as a desktop computer, a notebook computer, a tablet device, a smartphone, or a specialized terminal, and is equipped with an input unit such as a keyboard or touch panel, a pointing device, a display unit, and a communication interface. Terminal executes a logging client program that records user input events, application context, and displayed content. Terminal also executes a presentation client program that receives summaries or documents from server and displays them to the user.

Server uses a machine learning framework to construct and update a behavior learning model. In one embodiment, server implements the behavior learning model as a neural network having a sequence-processing architecture such as a recurrent neural network, a long short-term memory (LSTM) network, or a Transformer network. The behavior learning model receives behavioral feature data as input and outputs representations of behavioral patterns for each user or each group of users. Server uses another model, such as an emotion classifier, to estimate an emotion index based on character information and meta-information. Server further accesses a generative AI model, which may be implemented as a large-scale Transformer-based language model, and provides the generative AI model with a prompt sentence and structured context as input to obtain a generated summary or a generated document.

Terminal acquires operation information by observing user interactions with the terminal. Terminal records key press events, pointing device events, touch events, window focus changes, application activation and deactivation, resource access events, and error notifications. Terminal attaches timestamps and user identifiers to each recorded event. Terminal also acquires display information by recording identifiers of displayed resources such as document names, uniform resource locators (URLs), and window titles, and may additionally extract textual content from the screen using an optical character recognition module. Terminal stores the operation information and the display information in a local buffer and periodically transmits accumulated records to server via the communication network using a secure protocol.

Server receives batched operation information and display information from multiple terminals and stores the received data in persistent storage. Server maintains, for each user, a time-series of events. Server preprocesses the time-series by sorting events based on timestamps, merging adjacent events that belong to the same context, and removing unnecessary information. For example, server identifies identical operations that are repeated within a predetermined short time window and consolidates them into a single event having an extended duration field. Server also removes transient focus changes that do not result in semantically meaningful content changes. By performing this preprocessing, server reduces data volume and noise, which leads to improved computational efficiency and improved learning stability for downstream models.

Server generates behavioral feature data by converting each preprocessed event into a numerical or symbolic representation. Server may assign integer identifiers to frequently occurring actions such as “open document,” “edit spreadsheet,” “reply to message,” or “browse web resource,” and convert these identifiers into dense vectors through an embedding layer. Server may also encode temporal features, such as elapsed time since the previous event and the absolute time of day, as numerical values. Server aggregates event-level features into sequences corresponding to sessions or days and stores these sequences as behavioral feature data. Because the behavioral feature data uses a compact representation and excludes unnecessary information, server can perform faster sequence model training and inference, and can store a larger historical window for each user without exceeding storage constraints.

Server constructs the behavior learning model by training a neural network using the behavioral feature data. In one configuration, server defines a model having multiple layers, including an embedding layer for categorical inputs, one or more sequence-processing layers (LSTM, gated recurrent units, or self-attention layers), and a final layer that outputs a latent representation of the behavioral pattern or a prediction of a next action. Server defines a loss function such as cross-entropy on predicted next actions or reconstruction error for autoencoding sequences, and uses gradient-based optimization to minimize the loss function. Server updates model parameters (weights and biases) by propagating errors backward through the network and adjusting parameters according to a learning rate. Server may use mini-batch training, regularization techniques, and early stopping criteria to improve generalization performance and to prevent overfitting. In this manner, server obtains a behavior learning model that captures recurring behavioral patterns and that can efficiently summarize or characterize user behavior based on new logs.

Server executes emotion analysis processing by receiving character information and meta-information derived from the operation information and the display information. For example, server extracts text typed by the user into communication applications or text appearing in documents and web pages. Server also uses meta-information such as resource categories, error codes, or system messages. Server applies an emotion analysis algorithm, such as a neural-network-based classifier, that outputs for each time interval an emotion label and an associated confidence value. Server aggregates emotion outputs by time window to produce an emotion index representing average or dominant emotional states. By using this emotion index, server can adapt generated outputs to the user's current or recent emotional state in a systematic and repeatable manner.

User provides inquiry information through the terminal. The inquiry information is typically a natural-language request asking for a summary or a document. For example, user may input the following prompt sentence via the terminal:
“Tell me what I did at work today.”

In another example, user may input:
“Create materials for tomorrow's meeting about this week's sales activities.”

Terminal transmits the inquiry information to server together with user identification and, optionally, explicit time constraints. Server analyzes the inquiry information by applying a parsing procedure or a natural-language understanding component to determine a time range and a target processing domain. For instance, server may interpret “today” as the current calendar day and “this week” as the current week, and may classify “sales activities” as a particular category of tasks. Server then retrieves preprocessed operation information, display information, behavioral patterns, and emotion indices corresponding to the determined time range and target processing domain.

Server generates a prompt sentence for a generative AI model by combining the retrieved context with explicit instructions. In one embodiment, server uses a template-based approach to construct the prompt sentence. For the work-summary example, server may build a prompt sentence such as:
“You are an assistant that summarizes user work activities. Based on the following operation logs and display contents for today, summarize the user's work in about 300 words, focusing on main tasks and outcomes. Emotion: The user appears moderately stressed. Use a supportive and encouraging tone. Logs: [structured summary of key events].”

For a factory-operations example, server may build a prompt sentence such as:
“You are an assistant for factory reporting. Based on the following machine operation log and sensor data, summarize today's factory work in about 3-5 sentences. Highlight any maintenance needs. Logs: [structured summary of machine events and sensor readings].”

Server couples the prompt sentence with structured context as input data. In some embodiments, server arranges the context into a sequence of lines representing key events, each line including time, action, resource, and additional attributes. This structured representation, combined with the prompt sentence, provides the generative AI model with more precise and less noisy context than simply concatenating raw log entries.

Server interacts with a generative AI model that uses a neural network architecture, such as a multi-layer Transformer network, pre-trained on large amounts of text data and optionally fine-tuned for summarization tasks. Server transmits the input data comprising the prompt sentence and context to the generative AI model and receives generated text as output. Server may specify generation parameters such as a maximum token length, a temperature parameter controlling randomness, and a top-k or top-p sampling parameter. The generative AI model applies a sequence of matrix multiplications, non-linear activations, and attention operations to compute probability distributions over output tokens and selects tokens according to the specified generation parameters.

Server receives the generated summary or generated document and applies content adjustment based on the emotion index and policy rules. For example, if the emotion index indicates a high level of stress, server may check the generated text for overly negative or alarmist expressions and may adjust phrasing to reduce additional stress, such as by emphasizing accomplishments and by framing issues as actionable steps. If the emotion index indicates a positive emotional state, server may allow more celebratory language and highlight positive trends. Policy rules can also enforce constraints such as removal of certain categories of information or enforcement of specific terminology. Server may implement these adjustments either by applying text transformation rules to the generated text or by issuing a secondary prompt sentence to the generative AI model instructing it to rewrite the text under specified constraints.

Server converts the adjusted output information into a predetermined display format suitable for terminal. For example, server may convert the text into a structured markup format for display in a web interface, or into a file format for documents that can be opened by office applications. Server transmits the formatted output information to terminal over the communication network. Terminal receives the output information and displays it to the user via the display unit. Terminal may also provide interactive controls allowing the user to scroll, search, annotate, or edit the generated summary or document.

User may provide feedback regarding the presented summary or document. For example, user may assign a rating, may select a reason for dissatisfaction, or may directly edit the text. Terminal captures this evaluation information and correction information and transmits it to server. Server associates the feedback with the underlying operation information, display information, prompt sentence, emotion index, and generated text stored in the database. Server uses the associated information as training data to refine the behavior learning model and the prompt generation parameters. For example, if summaries that omit certain categories of events consistently receive low ratings, server may adjust template weights to ensure that such events are included more prominently in future prompts. If certain phrases frequently require user correction, server may adjust policy rules or instruct the generative AI model to avoid those phrases.

By structuring operation information and display information into preprocessed, noise-reduced, and behaviorally meaningful sequences, server improves data management and reduces communication and computation costs. Because server performs feature extraction before model processing, the volume of data processed by the behavior learning model and the generative AI model is reduced, which leads to faster training and inference and improved scalability as the number of users increases. By maintaining an explicit behavior learning model and a time-resolved emotion index, server provides the generative AI model with richer context that cannot be easily generated by a human on demand, enabling more accurate and personalized generation than manual prompting.

The described system improves computer technology rather than merely automating human work. Server employs specific internal data structures, such as time-ordered event sequences, feature vectors, and emotion indices, and uses specific algorithms, such as noise filtering, sequence modeling, and prompt generation, to manage and process large-scale behavioral data efficiently. These techniques result in improved processing speed due to reduced input dimensionality, increased accuracy through behavior-and emotion-aware context, reduced error rates in generated summaries and documents, and reduced communication load through batched and filtered log transmission. The use of machine-learned models such as the behavior learning model and the emotion analysis model follows clearly defined training procedures, including choice of loss functions, gradient-based optimization, and parameter update rules, and is integrated into an overall system that provides technical benefits in terms of data processing efficiency and output quality.

In variants of this embodiment, server may employ different neural network architectures for the behavior learning model, such as convolutional neural networks applied to event windows, or graph neural networks that capture relationships between resources and actions. Server may also use different emotion analysis techniques, including models that consider acoustic features when audio data is available. Terminal may be implemented on various hardware platforms, including embedded devices in industrial environments, where operation information includes control signals for machinery and display information includes status indicators. In such environments, server-generated documents may include maintenance instructions or operational summaries that are used to configure or schedule machine operations, thereby connecting the system to physical machine control.

Additionally, server may implement alternative prompt generation strategies, such as learning prompt templates via reinforcement learning from user feedback or using rule-based systems to select context segments based on task type. These variations still follow the core approach of constructing structured prompt sentences enriched with behavioral patterns and emotion indices and supplying them, together with compact context, to a generative AI model. As a result, the system consistently provides technical improvements in handling and interpreting large volumes of user activity data and in generating context-aware, emotion-aware text outputs that are computed more efficiently and with higher relevance than conventional approaches.

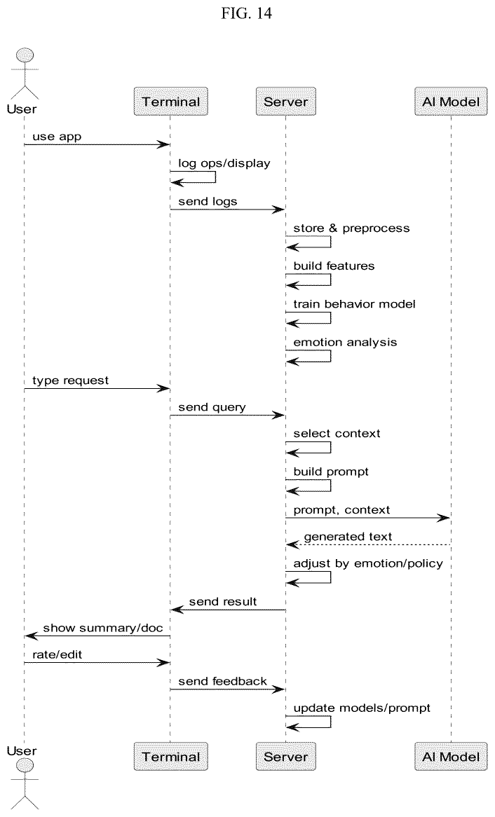

The following describes the processing flow using FIG. 14.
Step 1:

Terminal acquires operation information and display information.

Terminal monitors user interactions with the information processing apparatus and records operation information including key presses, pointing device actions, touch events, application launches, window focus changes, and error events. Terminal also records display information including window titles, document names, resource identifiers, and textual content extracted from the display using a text-capture or optical character recognition module. The input of this step is raw interaction signals from input devices and graphical output from the display subsystem. Terminal converts these raw signals into structured log records by attaching timestamps, user identifiers, and event types, and stores the resulting records in a local buffer as the output.
Step 2:

Terminal transmits batched logs to server.

Terminal groups the buffered operation information and display information into batches according to a time interval or a record count threshold. The input of this step is a set of locally stored log records. Terminal serializes each batch into a structured format such as a time-ordered sequence of records, applies compression if configured, and transmits the serialized data to server over a secure communication channel. The output of this step is a network message containing batched logs delivered to server.
Step 3:

Server receives and stores raw logs.

Server accepts incoming network messages from multiple terminals via a network interface. The input of this step is a received batch of operation information and display information. Server validates the batch by checking authentication tokens and data format, then parses the serialized records into internal data structures. Server writes validated records to persistent storage, for example, inserting event records into a time-series table and storing large display artifacts into an object store. The output of this step is a set of stored raw log records associated with a user identifier and timestamps.
Step 4:

Server preprocesses logs and removes unnecessary information.

Server loads raw log records from persistent storage for a selected user and time range. The input of this step is a collection of stored operation information and display information. Server sorts events by timestamp, merges adjacent events belonging to the same context, and identifies patterns such as identical operations repeated within a short time window. Server removes or consolidates such unnecessary information by converting multiple redundant entries into a single entry with an aggregate duration and by discarding transient focus changes that do not change visible content. The output of this step is a sequence of preprocessed event records that are time-ordered and noise-reduced.
Step 5:

Server generates behavioral feature data.

Server converts preprocessed event records into numerical features suitable for machine learning. The input of this step is the time-ordered sequence of preprocessed operation information and display information. Server assigns categorical identifiers to action types, applications, and resource categories, converts these identifiers into dense vectors using an embedding mapping, and computes temporal features such as elapsed time since the previous event and session start time. Server aggregates event-level features into sequences corresponding to sessions or days, forming behavioral feature data. The output of this step is a set of feature sequences representing user behavior over time.
Step 6:

Server trains or updates a behavior learning model.

Server uses the behavioral feature data as training input for a machine learning model. The input of this step is a set of feature sequences and, optionally, labels such as next-action identifiers or cluster identifiers. Server feeds the sequences into a neural network with sequence-processing layers and computes a loss value using a predefined loss function such as cross-entropy or reconstruction error. Server performs backpropagation to compute gradients of the loss with respect to model parameters, and updates the parameters using an optimization algorithm such as stochastic gradient descent. The output of this step is an updated behavior learning model that encodes behavioral patterns.
Step 7:

Server performs emotion analysis and creates an emotion index.

Server extracts character information and meta-information from the preprocessed logs. The input of this step is preprocessed operation information and display information including text typed by the user and text shown on the screen, and meta-information such as resource categories and error codes. Server applies an emotion analysis algorithm, for example a neural classifier, to each text segment to estimate an emotional state label and an associated confidence score. Server aggregates estimated emotions for each time interval by computing dominant labels or weighted averages, and records these values as an emotion index tied to the corresponding time intervals. The output of this step is a time-resolved emotion index for the user.
Step 8:

User submits inquiry information to request a summary or document.

User operates terminal to input a natural-language request, such as “Tell me what I did at work today” or “Create materials for tomorrow's meeting about this week's sales activities.” The input of this step is the user's intent and the user's text entry. Terminal captures the entered text as inquiry information, attaches user identification and optional parameters such as a time range, and transmits the inquiry information to server. The output of this step is a structured request message delivered to server.
Step 9:

Server determines a time range and a target processing domain.

Server receives the inquiry information from terminal. The input of this step is the structured request message including the user's text and metadata. Server applies a parsing procedure to interpret temporal expressions such as “today” or “this week” and maps them to explicit time ranges. Server also classifies the content of the request to determine a target processing domain such as daily work summary, project-specific summary, or factory operation report. The output of this step is a resolved time range and a target processing domain associated with the user's request.
Step 10:

Server retrieves relevant preprocessed logs, behavioral patterns, and emotion indices.

Server accesses persistent storage using the resolved time range and the user identifier. The input of this step is the time range, user identifier, and target processing domain. Server retrieves preprocessed operation information, preprocessed display information, and emotion indices for the specified period, and may also compute or retrieve a representation of the behavioral pattern for that period from the behavior learning model. The output of this step is a set of context data including filtered logs, behavioral pattern data, and emotion index values for the requested time range.
Step 11:

Server constructs a prompt sentence and input data for a generative AI model.

Server uses the retrieved context data to build a natural-language instruction for the generative AI model. The input of this step is the context data and the parsed inquiry information. Server selects key events based on criteria such as duration or importance, formats them as concise log lines, and embeds them into a template text. Server also incorporates the behavioral pattern information and the emotion index into the template. For example, server may construct a prompt sentence such as “You are an assistant that summarizes user work activities. Based on the following operation logs and display contents for today, summarize the user's work in about 300 words, focusing on main tasks and outcomes. Emotion: The user appears moderately stressed. Use a supportive and encouraging tone. Logs: [event lines].” Server assembles the prompt sentence and the formatted context into input data suitable for the generative AI model. The output of this step is a prompt sentence and associated input data ready for text generation.
Step 12:

Server generates a summary or document using a generative AI model.

Server transmits the input data from the previous step to a generative AI model. The input of this step is the prompt sentence and structured context. Server invokes the generative AI model with specified generation parameters such as a maximum token count and a sampling strategy, and receives token probabilities at each generation step from the model. Server selects tokens according to the probabilities and constructs a natural-language output sequence representing a summary or document. The output of this step is a generated text that describes user work content or other requested content.
Step 13:

Server adjusts generated content based on the emotion index and policy rules.

Server analyzes the generated text and applies modification rules that depend on emotion indices and policy constraints. The input of this step is the generated text and the emotion index corresponding to the time range, as well as applicable policy rules. Server detects expressions that may conflict with policy or that may be inappropriate given the emotional state, and rewrites or reorders parts of the text to emphasize positive achievements or actionable guidance when stress is high, or to maintain neutrality when required. Server may also shorten or expand certain sections according to the user's typical preferences learned from behavior patterns. The output of this step is adjusted output information that is tailored to the emotional state and policy.
Step 14:

Server formats output information and transmits it to terminal.

Server converts the adjusted text into a display format appropriate for the terminal. The input of this step is the adjusted output information. Server may wrap the text in a markup structure, embed headings and bullet points, or bundle it into a document file. Server then sends the formatted output information to terminal over the communication network. The output of this step is a formatted summary or document delivered to terminal.
Step 15:

Terminal presents the output to user.

Terminal receives the formatted summary or document from server. The input of this step is the formatted output information. Terminal renders the text on the display, for example in a dedicated viewer window or within an existing application, and provides interface elements for scrolling, searching, and editing. The output of this step is the visual or audible presentation of the generated information to user.
Step 16:

User reviews the generated information and optionally provides feedback.

User reads or listens to the presented summary or document and may perform further actions such as editing text, assigning a rating, or choosing options such as “useful” or “not useful.”

The input of this step is the displayed content and optional interface controls. User's actions result in evaluation information and correction information that are captured by terminal. The output of this step is feedback data describing user judgment and edits.
Step 17:

Terminal sends feedback to server.

Terminal packages the evaluation information and correction information together with identifiers for the related summary or document. The input of this step is user feedback and references to the original generation session. Terminal transmits this feedback data to server using a secure communication channel. The output of this step is a feedback message received by server.
Step 18:

Server associates feedback with generation context and updates internal models.

Server receives the feedback message from terminal. The input of this step is the feedback data and references to previous logs, prompts, and emotion indices. Server retrieves the operation information, display information, prompt sentence, emotion index, and generated text that correspond to the feedback. Server stores these as associated information and may use them as additional training examples. Server updates parameters of the behavior learning model or parameters of the prompt generation process by performing incremental training or by adjusting rule weights based on aggregated feedback statistics. The output of this step is an adjusted model configuration and updated prompt generation parameters that will influence subsequent summaries or documents.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

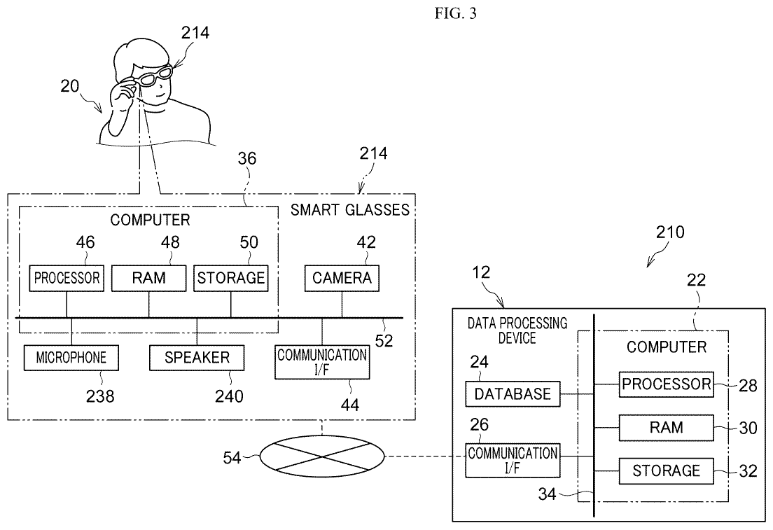

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

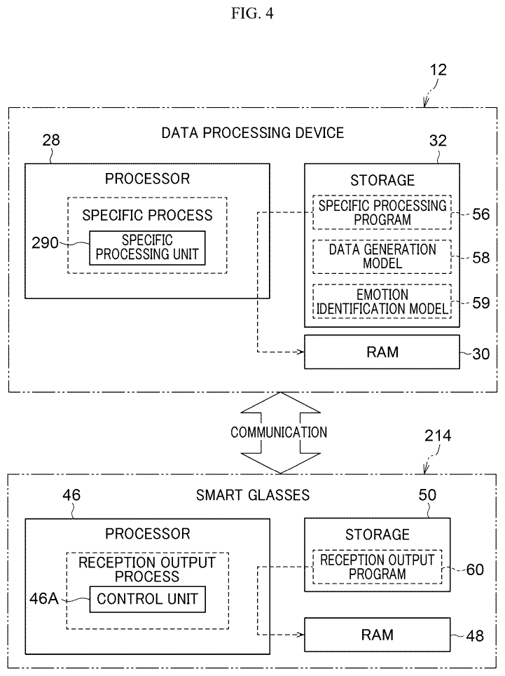

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

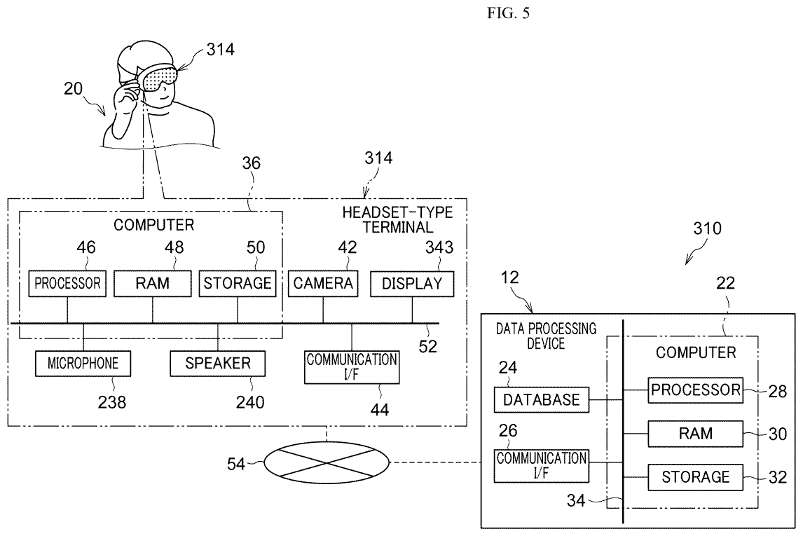

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

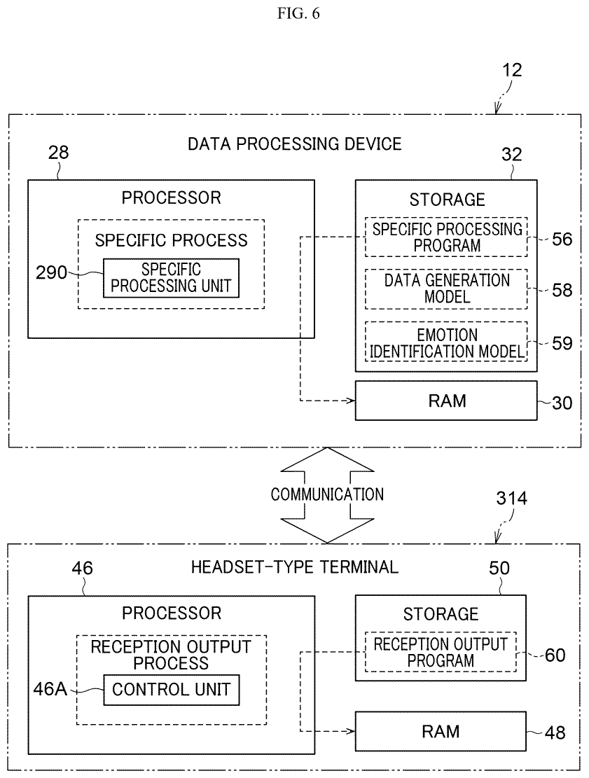

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

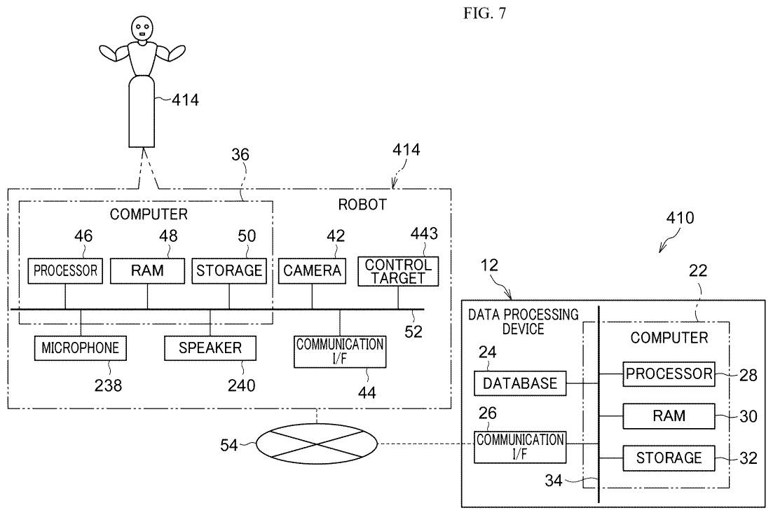

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

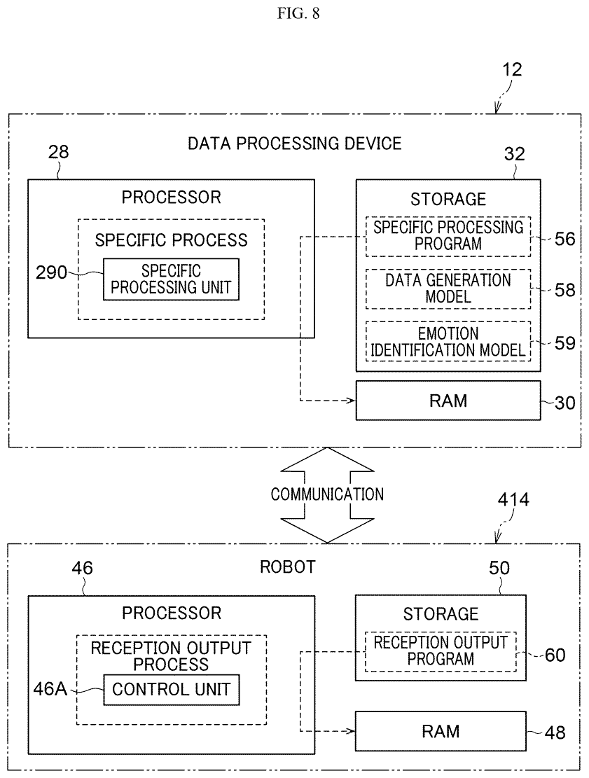

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

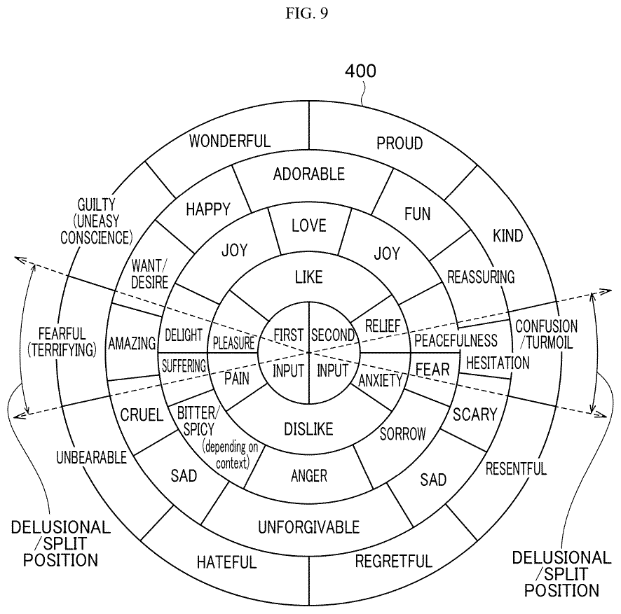

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

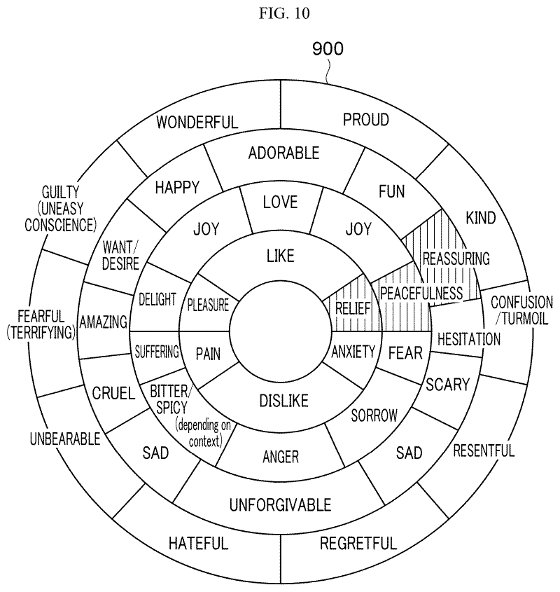

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
monitor input operations and instruction operations on an information processing terminal of a user, and acquire, as structured data, operation logs relating to the input operations and the instruction operations and display contents relating to screen information displayed on the information processing terminal, the structured data including at least time information, an execution application type, a window identifier, and a document identifier, and identify, on a basis of a correspondence between the input operations and the display contents, a work context for each application or for each window, assign a context identifier to the work context, associate the context identifier with the operation logs and the display contents, and generate work session data that is arranged in chronological order, and divide the work session data in accordance with a predetermined threshold, add user identification information and time range information to the divided work session data, and transmit resulting log data packets to a server via a communication network, and in the server, receive the log data packets, validate the log data packets, normalize data items including application names, document identification information, and network resource identification information, and store the normalized data in an accumulated data storage device with indexing based on a user identifier, time information, and application type, and in the server, receive request information including a prompt sentence input by the user, extract, from the accumulated data storage device, work session data on a basis of time conditions and content conditions described in the prompt sentence, and generate model input data that has been preprocessed as a chronological work history and grouped activities, and in the server, input the prompt sentence and the model input data into a generative artificial intelligence model capable of natural language generation, cause the generative artificial intelligence model to learn a behavior pattern of the user on a basis of the work session data, and automatically generate a summary text or a document text of work contents on a basis of the behavior pattern and the prompt sentence, and
in the server, perform emotion analysis processing using text information relating to the operation logs and the display contents and the prompt sentence as inputs, estimate an emotional state of the user, and adjust an expression format or emphasis portions of the automatically generated summary text or document text in accordance with the estimated emotional state, and
in the server, transmit the adjusted summary text or document text to the information processing terminal of the user and provide the summary text or the document text as display data in response to a request of the user.

### (Supplementary 2)

The system according to supplementary 1,
wherein the processor is configured to
supply the operation logs and the display contents stored in the accumulated data storage device, in time order for each user, as learning data to the generative artificial intelligence model on a continuous basis, and improve estimation accuracy of the behavior pattern and the emotional state of the user by update learning.

### (Supplementary 3)

The system according to supplementary 1,
wherein the processor is configured to
associate a new prompt sentence input by the user with an already generated summary text or document text and with the work session data in the accumulated data storage device, re-input the new prompt sentence and the associated information into the generative artificial intelligence model, and regenerate or additionally generate a summary text or a document text relating to a specific period, a specific work context, or a specific subject in accordance with a condition change or a narrowing condition included in the new prompt sentence.

### Application Example 1

### (Supplementary 1)

A system comprising a processor,
wherein the processor is configured to
acquire operation history information and display information or work information from an information processing apparatus of a user and from a machine apparatus, arrange the operation history information and the display information or the work information in chronological order, remove noise from the arranged information, group the chronologically arranged information on a session basis or on a work-cycle basis, and convert the information for each session or each work cycle into a text sequence,
convert the text sequence into a token sequence, train or update a generative AI model by using the token sequence, and model a behavior pattern of the user and a work pattern of the machine apparatus by using the generative AI model, input, to the generative AI model, an input sentence including a prompt sentence automatically generated by the system and a prompt sentence received from the user, together with time-series information associated with the session or the work cycle, and generate summary information or document information regarding business content of the user and analysis information regarding a work process of the machine apparatus,
calculate a work-efficiency index on the basis of the analysis information, generate an improvement proposal or an optimization proposal for the work process of the machine apparatus according to the work-efficiency index, and generate the improvement proposal or the optimization proposal in a natural-language form by using the generative AI model, analyze an emotion of the user and, on the basis of the analyzed emotion, adjust an expression content or a detail level of the summary information, the document information, and the improvement proposal or the optimization proposal, and
output the summary information, the document information, and the improvement proposal or the optimization proposal to a user terminal.

### (Supplementary 2)

The system according to supplementary 1,
wherein the processor is configured to
generate a training data set including the text sequence, fine-tune, on the basis of the time-series information, a generative AI model having a natural-language generation function by using the training data set, and enable the fine-tuned generative AI model to generate, by a single model, the summary information regarding the business content of the user and explanatory information regarding the work-efficiency index of the machine apparatus.

### (Supplementary 3)

The system according to supplementary 1,
wherein the processor is configured to
include, as input information constituting the prompt sentence, inquiry content from the user, meta information regarding the session or the work cycle, the work-efficiency index, and a result of the emotion analysis, and thereby dynamically adjust, for each user or for each work process, the summary information, the document information, and the improvement proposal or the optimization proposal output from the generative AI model.

### Example 2

### (Supplementary 1)

A system comprising a processor,
wherein the processor is configured to
acquire operation information and display information from an information processing apparatus used by a user, and record the operation information and the display information in time series,
organize the operation information and the display information recorded in time series based on time information, remove unnecessary information and erroneous information, and generate cleaned time-series data for learning,
structure the cleaned time-series data as behavior sequences for each individual user and each individual usage session, convert the behavior sequences into textual sequences including description information and instruction information, and generate a prompt sentence for input to a generative artificial intelligence model,
train or adjust the generative artificial intelligence model by using the prompt sentence and the behavior sequences as learning data, and generate a behavior prediction model representing a behavior pattern and an emotional state of the user,
generate, based on the behavior prediction model and a prompt sentence generated in accordance with a current operation situation of the user, prediction information including a next operation of the user or a plurality of candidate operations of the user,
generate a summary of a work content of the user or automatically generate a work-related document based on the prediction information, and adjust content of the summary or the work-related document in consideration of the emotional state of the user estimated by the behavior prediction model, and
acquire feedback information including acceptance information or rejection information from the user with respect to the prediction information, and perform relearning of the behavior prediction model by using the feedback information as additional learning data for the generative artificial intelligence model and update a behavior prediction accuracy and a content of the prediction information.

### (Supplementary 2)

The system according to supplementary 1,
wherein the processor is configured to generate a plurality of learning pairs by associating a plurality of prompt sentences, which are generated based on the acquired operation information and display information, with actual subsequent operation information of the user corresponding to each of the prompt sentences, and sequentially train the generative artificial intelligence model by using the learning pairs so as to predict a next operation in time series and estimate the behavior pattern and the emotional state of the user with high accuracy.

### (Supplementary 3)

The system according to supplementary 1,
wherein the processor is configured to, when generating the prompt sentence to be input to the generative artificial intelligence model based on the acquired operation information and display information, add instruction information including an inquiry content from the user to the prompt sentence, generate the summary of the work content of the user or the work-related document as a response of the generative artificial intelligence model to the prompt sentence, and adjust a writing style, a level of detail, or a presentation format of the summary or the work-related document based on the emotional state estimated by an emotion analysis unit.

### Application Example 2

### (Supplementary 1)

A system comprising a processor,
wherein the processor is configured to
acquire operation information and display information from an information processing apparatus operated by a user, and preprocess the operation information and the display information by arranging the operation information and the display information in chronological order based on time-series information and removing unnecessary information including identical operations repeated within a short time period,
generate behavioral feature data from the preprocessed operation information and the preprocessed display information, execute a machine learning algorithm using the behavioral feature data as input, and construct or update a behavior learning model that learns a behavioral pattern of the user,
execute an emotion analysis algorithm based on character information and meta-information extracted from the operation information and the display information, estimate an emotional state of the user for each time interval, and record the emotional state as an emotion index, analyze inquiry information received from the user, specify a time range and a target processing domain corresponding to the inquiry information, and acquire preprocessed operation information, preprocessed display information, the behavioral pattern, and the emotion index corresponding to the time range,
generate a prompt sentence for summarizing behavioral content or work content in a target period based on the acquired operation information, display information, behavioral pattern, and emotion index, and generate input data in which the prompt sentence and the acquired information are incorporated,
input the input data generated by a prompt generation unit into a generative artificial intelligence model, and cause the generative artificial intelligence model to generate, in a natural language, a summary of work content of the user or a document as a generated summary,
automatically adjust an expression style, a writing style, and emphasized content of the generated summary based on the emotion index and a policy rule, and generate output information corresponding to the emotional state of the user, and
convert the output information into a predetermined display format, transmit the output information to the information processing apparatus of the user, and cause the output information to be presented to the user.

### (Supplementary 2)

The system according to supplementary 1,
wherein the processor is configured to
incorporate context information including the behavioral pattern of the user and the emotion index into the prompt sentence in the prompt generation unit, and provide the generative artificial intelligence model with input data that takes the context information into account so as to cause the generative artificial intelligence model to generate a personalized summary or document for each user.

### (Supplementary 3)

The system according to supplementary 1,
wherein the processor is configured to
acquire evaluation information or correction information from the user with respect to the summary or document presented by a presentation control unit, associate the evaluation information or the correction information with the operation information, the display information, the prompt sentence, and the emotion index used for generation of the summary or the document, record the associated information, and update a parameter of the behavior learning model or a parameter of the prompt generation unit based on the associated information so as to improve accuracy of generation of subsequent summaries or documents.

What is claimed is:

1. A system comprising:
circuitry configured to:
acquire operation history information and at least one of display information or work information from an information processing apparatus of a user and from a machine apparatus;
arrange the acquired information in chronological order, remove noise from the arranged information, and group the chronologically arranged information on a session basis or on a work-cycle basis;
convert the grouped information for each session or each work cycle into a text sequence and convert the text sequence into a token sequence;
train or update a generative artificial intelligence model using the token sequence to model a behavior pattern of the user and a work pattern of the machine apparatus;
input to the generative artificial intelligence model an input sentence comprising a prompt sentence automatically generated by the circuitry together with time-series information associated with the session or the work cycle, to generate summary information or document information regarding business content of the user and analysis information regarding a work process of the machine apparatus;
calculate a work-efficiency index based on the analysis information and generate, using the generative artificial intelligence model, an improvement proposal or an optimization proposal for the work process of the machine apparatus in a natural language form according to the work-efficiency index; and
analyze an emotion of the user and adjust at least one of an expression content or a detail level of the summary information, the document information, and the improvement proposal or the optimization proposal based on the analyzed emotion, and output the summary information, the document information, and the improvement proposal or the optimization proposal to a user terminal.

2. The system of claim 1, wherein the circuitry is configured to:
receive a prompt sentence from the user and include the received prompt sentence in the input sentence together with the automatically generated prompt sentence.

3. The system of claim 2, wherein the input sentence further comprises context information derived from the time-series information associated with the session or the work cycle, and wherein the generative artificial intelligence model generates the summary information or the document information conditioned on the context information.

4. The system of claim 3, wherein the circuitry is configured to:
apply a session boundary detection algorithm to the chronologically arranged information to identify session boundaries based on at least one of a temporal gap threshold, an application transition criterion, or a work-cycle completion signal; and
group information segments between consecutive session boundaries as a session unit.

5. The system of claim 4, wherein removing noise from the arranged information comprises applying at least one of a duplicate event removal algorithm, an idle-period filtering algorithm, and an outlier detection algorithm to the chronologically arranged information prior to grouping.

6. The system of claim 1, wherein converting the grouped information into the text sequence comprises applying at least one of a template serialization algorithm and a structured event encoding algorithm to represent each event in the grouped information as a natural language description token.

7. The system of claim 6, wherein converting the text sequence into the token sequence comprises applying a subword tokenizer to the text sequence to generate a sequence of subword tokens, wherein the subword tokenizer applies a byte-pair encoding algorithm or a unigram language model algorithm to segment words into subword units.

8. The system of claim 1, wherein training or updating the generative artificial intelligence model using the token sequence comprises computing a language modeling loss function over the token sequence and updating model parameters using a gradient-based optimization algorithm.

9. The system of claim 8, wherein computing the language modeling loss function comprises applying a cross-entropy loss computed between predicted token probability distributions and ground-truth token identifiers for each position in the token sequence.

10. The system of claim 1, wherein calculating the work-efficiency index comprises applying a scoring function to the analysis information that computes at least one of a task completion rate, a cycle time distribution, and an error occurrence frequency derived from the work process of the machine apparatus.

11. The system of claim 10, wherein generating the improvement proposal or the optimization proposal comprises constructing a second prompt sentence encoding the work-efficiency index and the analysis information and inputting the second prompt sentence to the generative artificial intelligence model to generate the improvement proposal or the optimization proposal in natural language.

12. The system of claim 11, wherein the second prompt sentence specifies an output format constraint that instructs the generative artificial intelligence model to structure the improvement proposal or the optimization proposal into sections covering at least an identified bottleneck, a proposed countermeasure, and an expected effect.

13. The system of claim 1, wherein analyzing the emotion of the user comprises applying a statistical emotion analysis algorithm to at least one of text expressions in the operation history information and biometric data associated with the user to compute an emotional state score.

14. The system of claim 13, wherein the emotional state score is mapped to an emotional state category comprising at least one of a stressed state, a neutral state, a focused state, and a fatigued state, and wherein adjusting the detail level comprises selecting a response verbosity parameter indexed by emotional state category.

15. The system of claim 14, wherein adjusting the expression content based on the emotional state category comprises incorporating an emotional state instruction token into the automatically generated prompt sentence that directs the generative artificial intelligence model to generate summary information in a tone and structure appropriate for the emotional state category.

16. The system of claim 1, wherein the operation history information comprises at least one of keyboard input events, mouse operation events, application state transitions, command execution records, and display content snapshots acquired from the information processing apparatus.

17. The system of claim 16, wherein the work information acquired from the machine apparatus comprises at least one of position information, operation state identifiers, task cycle identifiers, load measurements, and timestamps associated with work tasks performed by the machine apparatus.

18. A system comprising:
circuitry configured to:
acquire operation history information and at least one of display information or work information from an information processing apparatus and a machine apparatus;
arrange the acquired information in chronological order, remove noise, group the information on a session basis or a work-cycle basis, and convert the grouped information into a token sequence;
train or update a generative artificial intelligence model using the token sequence to model a behavior pattern of the information processing apparatus user and a work pattern of the machine apparatus;
input a prompt sentence together with time-series information to the generative artificial intelligence model to generate summary information and analysis information regarding a work process;
calculate a work-efficiency index based on the analysis information and generate, using the generative artificial intelligence model, an improvement proposal in natural language form; and
analyze an emotion of the user and adjust at least one of an expression content and a detail level of the summary information and the improvement proposal based on the analyzed emotion.

19. The system of claim 18, wherein the circuitry is configured to apply a subword tokenizer using a byte-pair encoding algorithm or a unigram language model algorithm to convert the text sequence into the token sequence, and to compute a language modeling loss function and update model parameters using a gradient-based optimization algorithm to train or update the generative artificial intelligence model.

20. A method performed by circuitry, the method comprising:
acquiring operation history information and at least one of display information or work information from an information processing apparatus of a user and from a machine apparatus;
arranging the acquired information in chronological order, removing noise, and grouping the information on a session basis or a work-cycle basis;
converting the grouped information into a text sequence and a token sequence;
training or updating a generative artificial intelligence model using the token sequence to model a behavior pattern of the user and a work pattern of the machine apparatus;
inputting to the generative artificial intelligence model an input sentence comprising a prompt sentence automatically generated by the circuitry together with time-series information associated with the session or the work cycle, to generate summary information and analysis information regarding a work process of the machine apparatus;
calculating a work-efficiency index based on the analysis information and generating, using the generative artificial intelligence model, an improvement proposal in natural language form; and
analyzing an emotion of the user and adjusting at least one of an expression content and a detail level of the summary information and the improvement proposal based on the analyzed emotion.
